(19) United States
(12) Patent Application Publication
(10) Pub. No.: US 2013/0143611 A1
(43) Pub. Date: Jun. 6, 2013

(54) MOBILE APPLICATION USING TEXT MESSAGING SERVICE PROTOCOL OR OTHER NETWORK PROTOCOL REQUIRING A DATA PLAN

(71) Applicants: Gopi Krishnan Nambiar, Bangalore (IN); Pranay Airan, Bangalore (IN)

(72) Inventors: Gopi Krishnan Nambiar, Bangalore (IN); Pranay Airan, Bangalore (IN)

(21) Appl. No.: 13/756,256

(22) Filed: Jan. 31, 2013

Related U.S. Application Data
(63) Continuation-in-part of application No. 12/728,169, filed on Mar. 19, 2010.

(30) Foreign Application Priority Data
Jan. 30, 2013 (IN) 490/KOL/2013

(51) Int. Cl. H04W 4/14

(52) U.S. Cl. CPC H04W 4/14
USPC 455/466

(57) ABSTRACT

A method for accessing content during a client server application session involves receiving an instruction to switch from using a network communication protocol to a text messaging service (TMS) protocol for data communication of the client server application session, wherein accessing the content is based on an user interface (UI) when the network communication protocol is used for the client server application session; sending a text identifier associated with a UI data item of the UI, where the text identifier is sent to a global textsite platform (GTP) using the TMS protocol, and where the UI data item is for requesting a portion of the content from a computer server; receiving a text page from the GTP using the TMS protocol, wherein the text page is derived from the portion of the content; and presenting the text page to a user during the client server application session.

### CROSS-REFERENCE TO RELATED APPLICATIONS

This application is a continuation-in-part (CIP) of U.S. patent application Ser. No. 12/728,169, filed on Mar. 19, 2010. Accordingly, this application claims benefit under 35 U.S.C. §120 to U.S. patent application Ser. No. 12/728,169. Accordingly, U.S. patent application Ser. No. 12/728,169 is hereby incorporated by reference in its entirety.

This application claims priority to Indian Patent Application No. 490/KOL/2013, filed on Jan. 30, 2013, and entitled: “A MOBILE APPLICATION USING TEXT MESSAGING SERVICE PROTOCOL OR OTHER NETWORK PROTOCOL REQUIRING A DATA PLAN” Accordingly, this application claims priority to Indian Patent Application No. 490/KOL/2013 under 35 U.S.C. §119(a). Indian Patent Application No. 490/KOL/2013 is hereby incorporated by reference in its entirety.

This application is related to copending U.S. patent application Ser. No. ______ (Attorney Docket No. 37202/529001), filed on Jan. 31, 2013, and entitled “SESSION PERSISTENCE FOR ACCESSING TEXTSITES,” which is also assigned to the assignee of the present application, the subject matter of which is incorporated by reference herein.

### BACKGROUND

Today's mobile devices, such as smart phones, allow users to browse the Internet from any location to obtain information on demand. As long as a user is in an area with the proper telecommunication network and subscribes to a data plan, the user is provided with access to the Internet for web browsing to obtain information such as phone numbers for service provides, map out a particular destination location, and obtain information relevant to the user's current or next activity. However, there are often instances in which a user wishes to access only limited information for a quick answer to a question (e.g., what are the next available show times for a particular movie?). In this scenario, browsing the website for the movie theater or a service provider website that provides movie show times, such as Fandango, may be cumbersome on the mobile device. Specifically, loading all the graphics and advertisements associated with websites on a mobile device can take additional time. In other words, the entire website may provide too much data to navigate through when a user desires only a specific piece of information. In addition, for mobile device users who do not subscribe to a data plan for browsing the Internet, are in an area without the proper telecommunication network, or do not have browsing capability on their mobile device, accessing such information on demand is not possible.

With the growth in smartphone applications market, more and more applications depend on Internet connection to function properly. However, especially in emerging market economies, when a potential user of an application does not have a data plan or other Internet connection, the application cannot be used effectively.

### SUMMARY

In general, in one aspect, the invention relates to a method for accessing content during a client server application session, comprising receiving, during the client server application session and by a user client device, an instruction to switch from using a network communication protocol to a text messaging service (TMS) protocol for data communication of the client server application session, wherein accessing the content is based on an user interface (UI) when the network communication protocol is used for the client server application session; sending, by the user client device and in response to the instruction, a text identifier associated with a UI data item of the UI, wherein the text identifier is sent to a global textsite platform (GTP) using the TMS protocol, and wherein the UI data item is for requesting a portion of the content from a computer server when the network communication protocol is used for the client server application session; receiving, by the user client device and in response to sending the text identifier, a text page from the GTP using the TMS protocol, wherein the text page is derived from the portion of the content; and presenting, by the user client device, the text page to a user during the client server application session.

In general, in one aspect, the invention relates to a system for accessing content during a client server application session, comprising a computer server storing the content and coupled to a global textsite platform (GTP); and a user client device coupled to the GTP and comprising a processor and memory storing instructions when executed by the processor comprising functionalities to: receive, during the client server application session, an instruction to switch from using a network communication protocol to a text messaging service (TMS) protocol for data communication of the client server application session, wherein accessing the content is based on an user interface (UI) when the network communication protocol is used for the client server application session; send, in response to the instruction, a text identifier associated with a UI data item of the UI, wherein the text identifier is sent to the GTP using the TMS protocol, wherein the UI data item is for requesting a portion of the content from the computer server when the network communication protocol is used for the client server application session; receive, in response to sending the text identifier, a text page from the GTP using the TMS protocol, wherein the text page is derived from the portion of the content; and present the text page to a user during the client server application session.

In general, in one aspect, the invention relates to a non-transitory computer readable storage medium comprising software instructions for accessing content during a client server application session, that when executed, comprise functionality for: receiving, during the client server application session and by a user client device, an instruction to switch from using a network communication protocol to a text messaging service (TMS) protocol for data communication of the client server application session, wherein accessing the content is based on an user interface (UI) when the network communication protocol is used for the client server application session; sending, by the user client device and in response to the instruction, a text identifier associated with a UI data item of the UI, wherein the text identifier is sent to a global textsite platform (GTP) using the TMS protocol, wherein the UI data item is for requesting a portion of the content from a computer server when the network communication protocol is used for the client server application session; receiving, by the user client device and in response to sending the text identifier, a text page from the GTP using the TMS protocol, wherein the text page is derived from the portion of the content; and presenting, by the user client device, the text page to a user during the client server application session.

Other aspects of the invention will be apparent from the following description and the appended claims.

### BRIEF DESCRIPTION OF DRAWINGS

FIGS. 1A and 1B show block diagrams of a system in accordance with one or more embodiments of the invention.

FIGS. 2A and 2B show flow charts of methods in accordance with one or more embodiments of the invention.

FIGS. 3A-3J show screenshots of an example in accordance with one or more embodiments of the invention.

FIGS. 4A-4H show screenshots of an example in accordance with one or more embodiments of the invention.

FIG. 5 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system for a mobile application to use text messaging service (TMS) protocol and/or other network protocol requiring a data plan. The TMS may be, for example, Short Messaging Service (SMS), Multi-media Messaging Service (MMS), Enhanced Messaging Service (EMS), or any other text messaging service which is now known or later developed. In one or more embodiments of the invention, a user uses the mobile application to obtain information from at least a website or a textsite. In one or more embodiments, a textsite is one or more pages of content that is made globally accessible via a TMS. In one or more embodiments, the textsite may also be accessible using additional network protocols (e.g., HTTP) other than the TMS. Similar to websites known today, which are made globally accessible via the Internet, a textsite includes a homepage and one or more text pages that are hierarchically and/or organizationally linked to the homepage for browsing information contained on one or more text pages of the textsite. In one or more embodiments, while using the mobile application, the user switches between the TMS protocol and other network protocol requiring a data plan. In one or more embodiments, the network protocol requiring a data plan may be used for the mobile application initially until a connection loss of the network protocol is detected. Subsequently, the TMS protocol is used as a back up to continue the mobile application session without interruption.

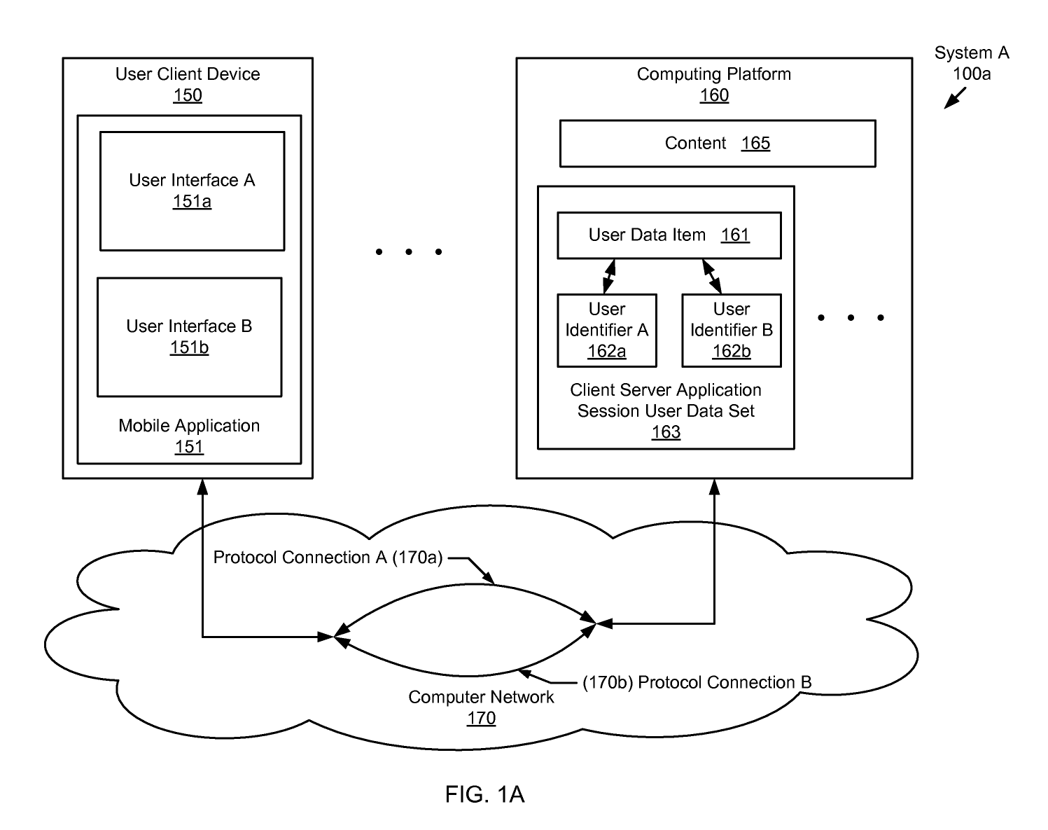

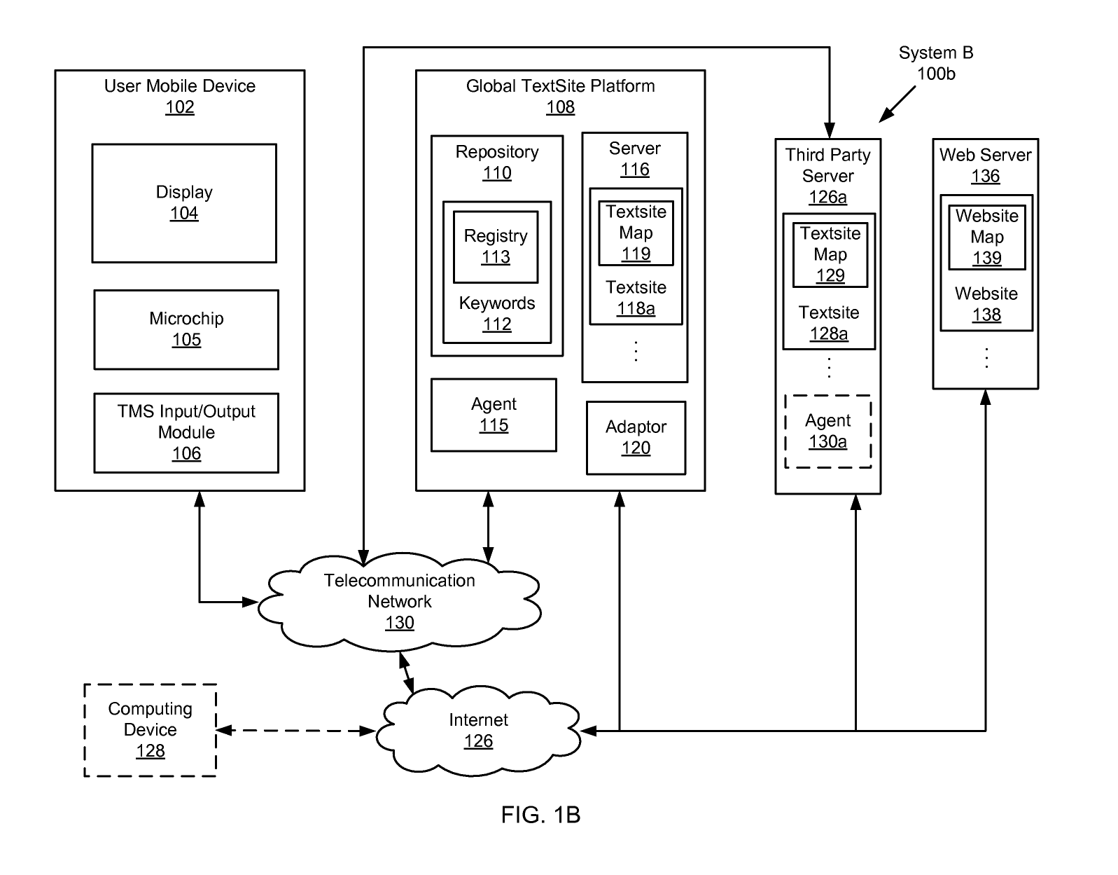

FIG. 1A shows a block diagram of a system (100a) for using the TMS protocol or other network protocol requiring a data plan in accordance with one or more embodiments of the invention. Specifically, the system (100a) includes a user client device (150) and a computing platform (160) coupled via a computer network (170). In one or more embodiments of the invention, one or more of the modules and elements shown in FIG. 1A may be omitted, repeated, and/or substituted. Accordingly, embodiments of the invention should not be considered limited to the specific arrangements of modules shown in FIG. 1A.

In one or more embodiments of the invention, the computer network (170) may include a cellular phone network, a wide area network, a local area network, a public switched telephone network (PSTN), or any other suitable network that facilitates the exchange of messages from one part of the network to another. In one or more embodiments, the computer network (170) is coupled to or overlap with the Internet. In one or more embodiments, one or more protocol connections (e.g., protocol connection A (170a), protocol connection B (170b)) may be established between the user client device (150) and the computing platform (160) via the computer network (170) to support data communication (e.g., sending and receiving messages or other data elements). For example, the protocol connection A (170a) may use the HTTP protocol, while the protocol connection B (170b) may use the text messaging service (TMS) protocol. The HTTP protocol and the TMS protocol are data communication protocols. In one or more embodiments, the protocol connection A (170a) (e.g., HTTP connection) may be connected (i.e., established) or disconnected (i.e., torn down), as directed by a user, according to specifics of the data communication protocol used. From time to time, the protocol connection A (170a) may be lost (i.e., disconnected without being directed by the user) resulting in a connection loss event. In one or more embodiments, the protocol connection B (170b) (e.g., TMS connection) may be statically connected.

In one or more embodiments of the invention, each of the computing platform (160) and the user client device (150) may include any computing device configured with computing, data storage, and network communication functionalities. Generally, the computing platform (160) is configured with high performance computing capability and large amount of data storage capacity to support multiple user client devices (e.g., user client device (150)) in a client server application environment. For example, the content (165) stored in the computing platform (160) may be accessed by multiple user client devices (e.g., user client device (150)) in a concurrent fashion. In one or more embodiments, the content (165) may include information stored in a repository (not shown) of the computing platform (160), information dynamically generated by the computing platform (160), and/or information dynamically retrieved by the computing platform (160) from other sources (not shown) that are accessible via the computer network (170a).

In one or more embodiments, the term “client server application session” refers to a sequence of activities performed by a mobile application of a particular user client device (e.g., mobile application (151) executing on the user client device (150)) in conjunction with a server application (not shown) executing on the computing platform (160). The mobile application and the server application are collected referred to as a client server application. For example, the sequence of activities of a client server application session may be in-between a user log-in and log-out events, within a pre-determined time period, terminated by a system time-out event, etc. In one or more embodiments, the sequence of activities of a client server application session includes requests from the user client device (150) to access the content (165) and the corresponding responses from the computing platform (160) to return the requested portions of the content (165). Throughout this disclosure, the terms “client server application session” and “mobile application session” may be used interchangeably depending on the context.

To facilitate multiple concurrent accesses to resources (e.g., content (165) and computing resources for retrieving requested portions thereof) of the computing platform (160) by different user client devices, user data items generated and/or otherwise used during separate client server application sessions are organized as separate client server application session user data sets (e.g., client server application session user data set (163)). In one or more embodiments, each client server application session user data set, or any user data item included therein, is tagged by a user identifier to differentiate among multiple concurrent client server application sessions associated with different user client devices. For example, the client server application session user data set (163) includes a user data item (161) that is generated and/or otherwise used during a client server application session of the user client device (150). Accordingly, the client server application session user data set (163) and/or the user data item (161) is tagged by a user identifier of the user client device (150). For example, the user identifier A (162a) is associated with communication between the user client device (150) and the computing platform (160) using a network protocol A (e.g., HTTP) via the protocol connection A (170a). Similarly, the user identifier B (162b) is associated with communication between the user client device (150) and the computing platform (160) using a network protocol B (e.g., TMS) via the protocol connection B (170b). In one or more embodiments, the user identifier A (162a) is extracted, encrypted, or otherwise derived from the user identifier B (162b). In one or more embodiments, the user identifier B (162b) is extracted, encrypted, or otherwise derived from the user identifier A (162a). In one or more embodiments, the user identifier A (162a) is the same as the user identifier B (162b). In one or more embodiments, same as the content (165), the client server application session user data set (163) is also stored in the repository (not shown) of the computing platform (160).

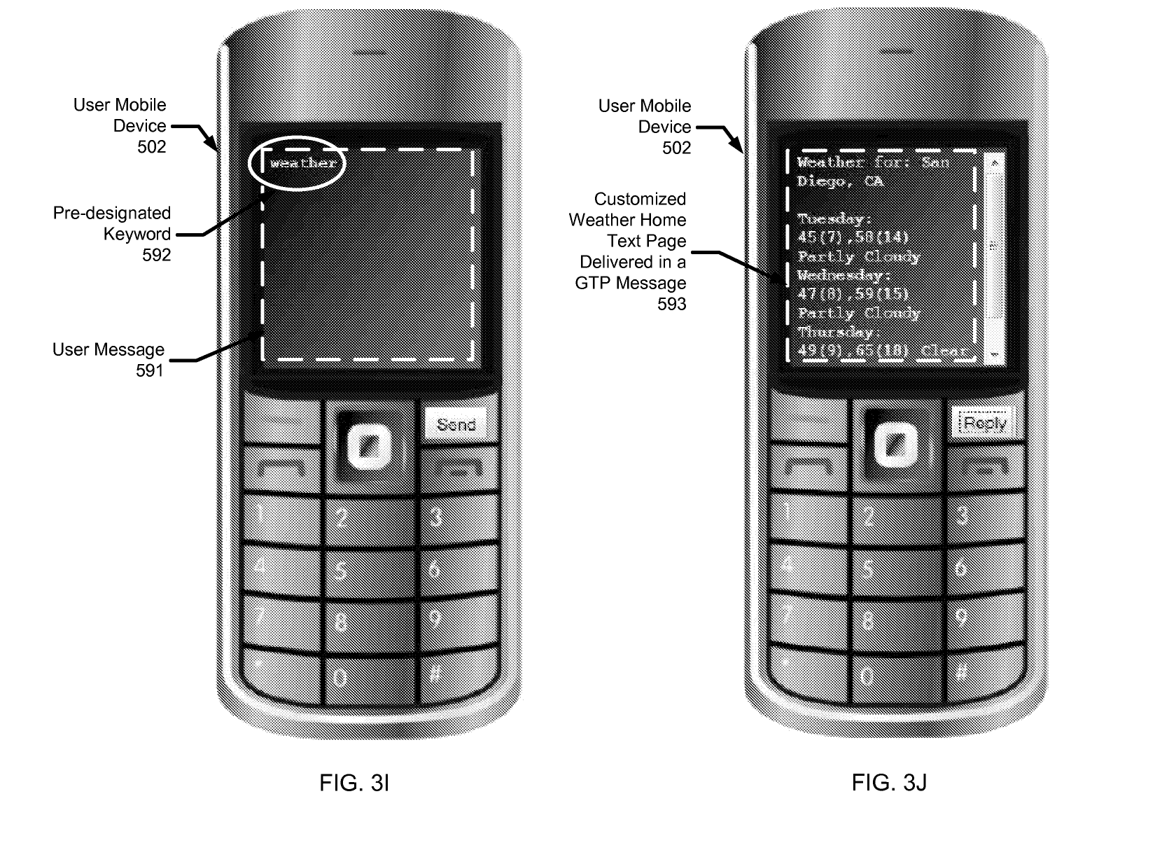

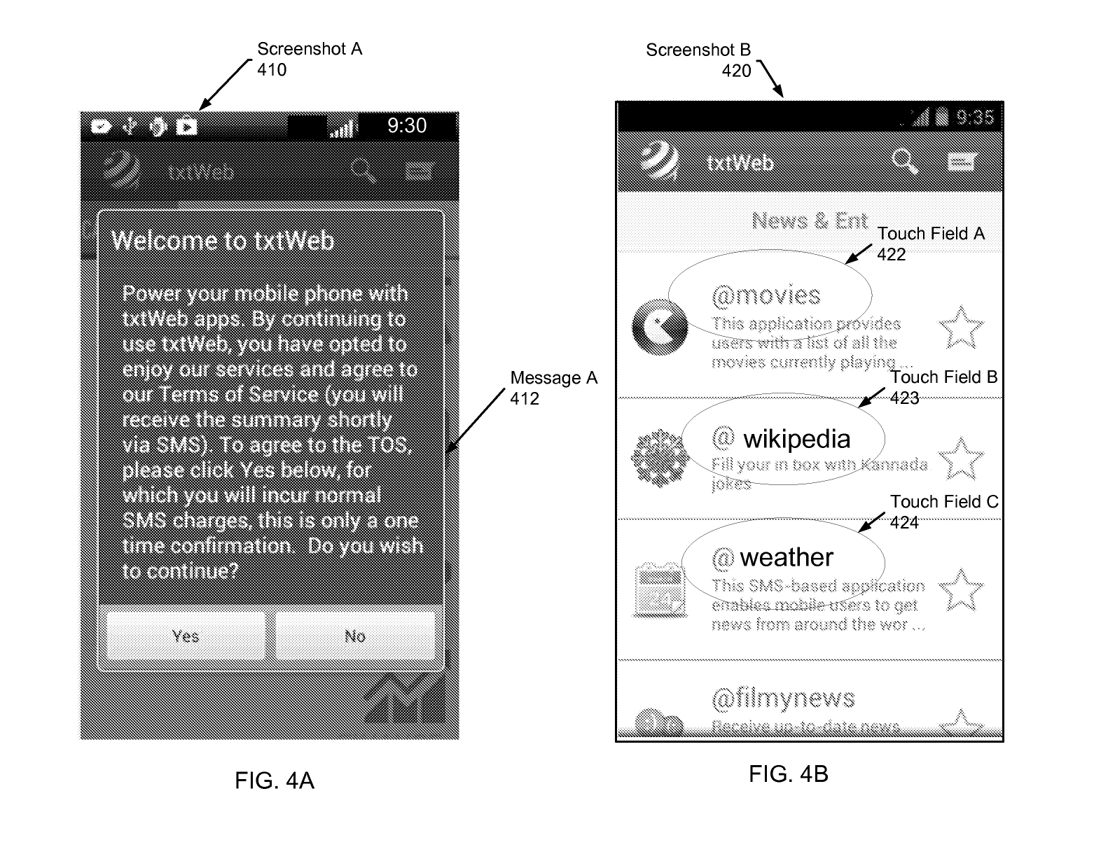

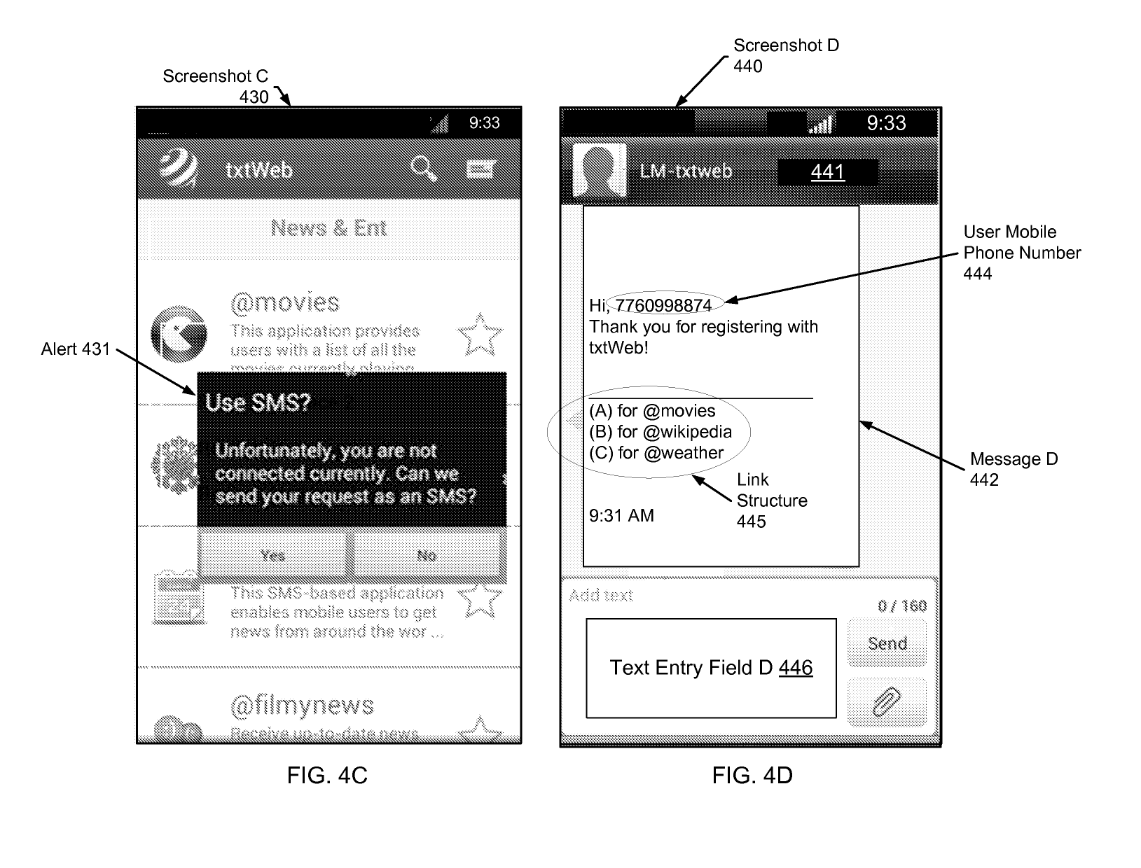

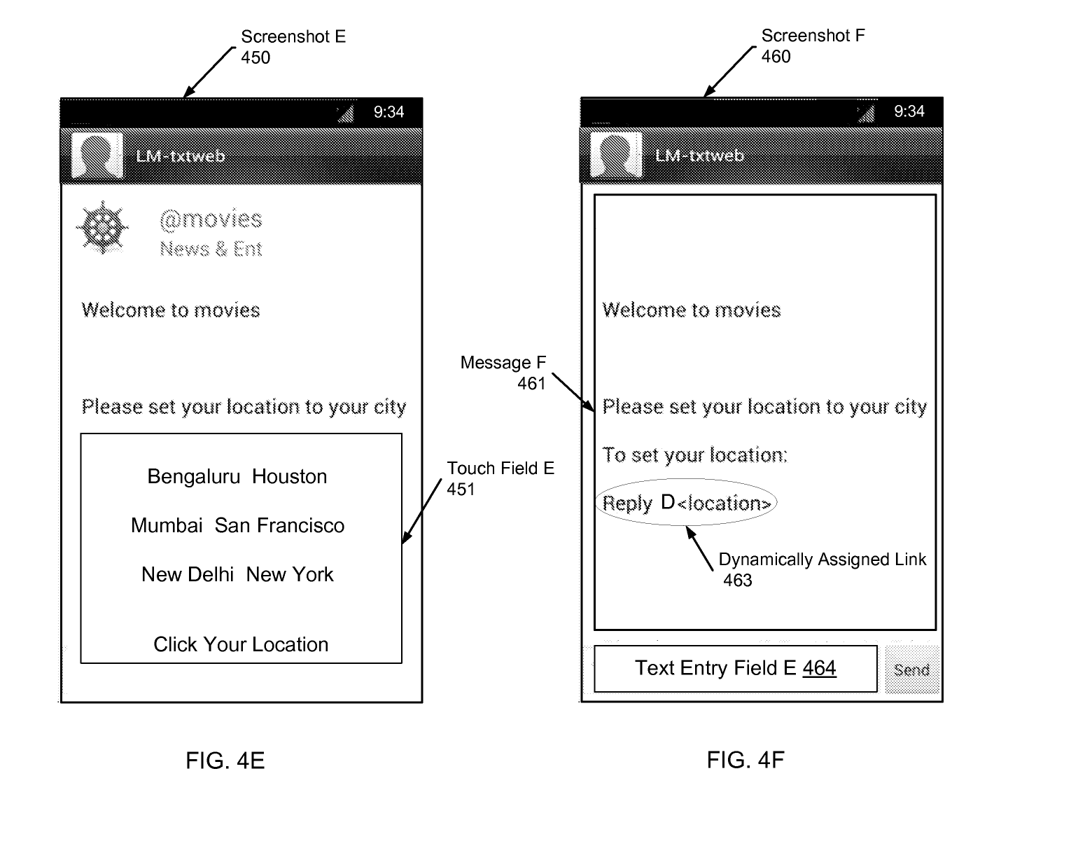

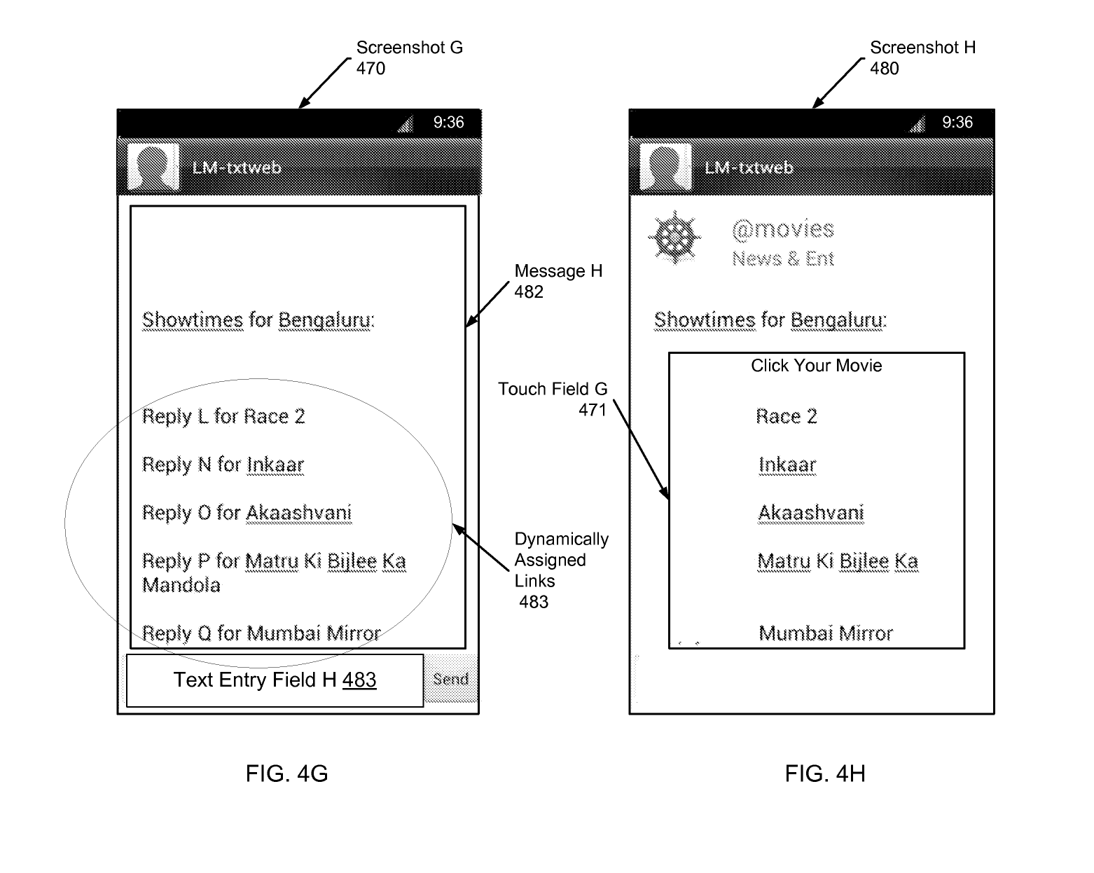

To present the requested portion of the content (165) returned from the computing platform (160) to a user, the user client device (150) is configured with user interface functionality, such as the user interface A (151a) and the user interface B (151b) of the mobile application (151). For example, the user interface A (151a) is associated with communication between the user client device (150) and the computing platform (160) using the network protocol A (e.g., HTTP) via the protocol connection A (170a). Similarly, the user interface B (151b) is associated with communication between the user client device (150) and the computing platform (160) using the network protocol B (e.g., TMS) via the protocol connection B (170b). In one or more embodiments, the user interface A (151a) is a subset of and/or derived from the user interface B (151b). In one or more embodiments, the user interface B (151b) is a subset of and/or derived from the user interface A (151a). In one or more embodiments, the user interface A (151a) and the user interface B (151b) are integrated as a single user interface. Examples of the user interface A (151a) and the user interface B (151b) are described in reference to FIGS. 4A-4H below.

In one or more embodiments of the invention, the content (165) is accessed via a server application (not shown) executing on the computing platform (160). In an example of such embodiments, the client server application session user data set (163) may include user configuration settings of the server application (not shown). In particular, the user data item (161) may be one of the user configuration settings. An example of the server application includes the agent (115) and/or the adaptor (120) described in reference to FIG. 1B below.

In one or more embodiments of the invention, the client server application session user data set (163) may include a set of dynamically assigned links for navigating the aforementioned textsite (not shown). In particular, the user data item (161) may be one of these dynamically assigned links for navigating the textsite (not shown). Additional details of the textsite (not shown) and navigating thereof are described in reference to FIGS. 1B, 2B, and 3A-3J.

In one or more embodiments, a portion of the sequence of activities in a client server application session may be conducted using the network protocol A (e.g., HTTP) via the protocol connection A (170a) while another portion of the sequence of activities may be conducted using the network protocol B (e.g., TMS) via the protocol connection B (170b). For example, the sequence of activities may initially be conducted via the established protocol connection A (170a) with HTTP protocol until a connection loss of the protocol connection A (170a) is detected. Subsequently, the protocol connection B (170b) with TMS protocol is used as a back up to continue conducting the remainder of the sequence of activities. In another example, the computer network (170) includes a cellular phone network where usage of the protocol connection A (170a) with HTTP protocol incurs additional service fee charge under a data plan offered by a network service provider. In this example, the sequence of activities may initially be conducted using the protocol connection A (170a) with HTTP protocol until the user decides to switch to using the protocol connection B (170b) with TMS protocol to conserve bandwidth usage metered according to the data plan. In one or more embodiments where the TMS protocol of the protocol connection B (170b) is used to substitute the other network protocol (e.g., HTTP) of the protocol connection A (170a) in a mobile application session, a TMS message received from the computing platform (160) is validated and identified as belonging to the mobile application session before it is further processed by the mobile application. In other words, any TMS message not intended for the current mobile application session is filtered and discarded from being processed by the mobile application. In one or more embodiments, the validated TMS message contains information returned by the computing platform (160) in response to a previous request sent by the mobile application (151) using the other network protocol (e.g., HTTP) of the protocol connection A (170a). In one or more embodiments, the returned information is retrieved by interpreting the validated TMS message and then presented to the user using the user interface A (151a). In one or more embodiments, the validate TMS message is directly presented to the user using the user interface B (151b) with minimum processing.

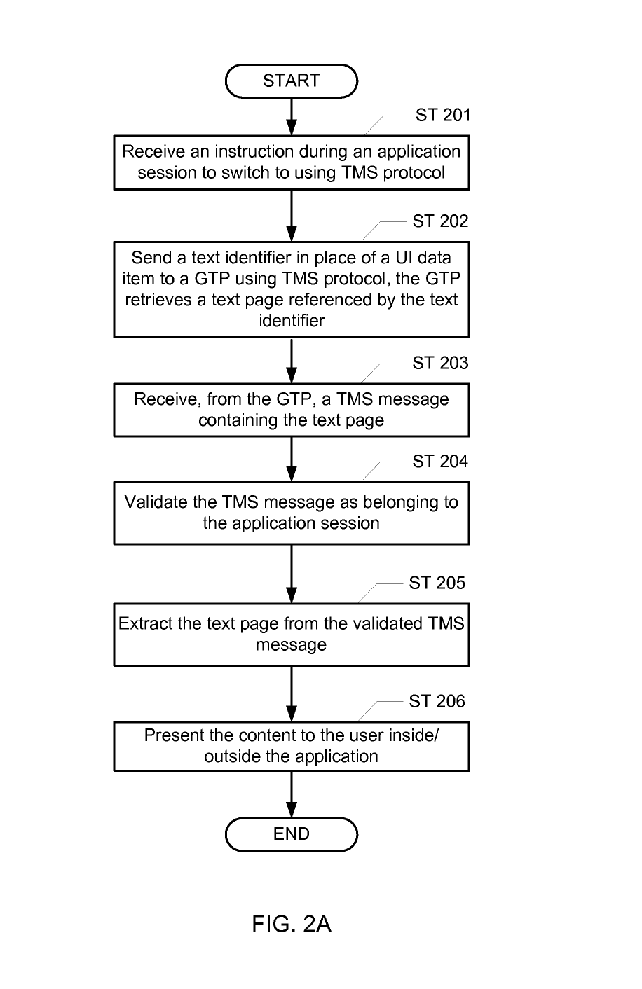

Additional details of using the TMS protocol, or other network protocol requiring a data plan, during a client server application session between the user client device (150) and the computing platform (160) are described in reference to FIG. 2A and FIGS. 4A-5H below.

FIG. 1B shows a block diagram of a system (100b) for accessing content from a textsite in accordance with one or more embodiments of the invention. Specifically, FIG. 1B shows the global textsite platform (GTP) (108), a user mobile device (102), and a computing device (128) coupled via the telecommunication network (130) and/or the Internet (126). In one or more embodiments of the invention, the system (100b) is an example of the system (100a) depicted in FIG. 1A above. In one or more embodiments, the protocol connection A (170a) and the protocol connection B (170b), depicted in FIG. 1 above, are established via the Internet (126) and/or the telecommunication network (130). Similarly, the user mobile device (102) and the server (116) of the GTP (108) are examples of the user client device (150) and the computing platform (160), respectively, depicted in FIG. 1A above. Further, within the GTP (108), the textsite (118a) and at least a portion of the keywords (112) are examples of the content (165) and the client server application session user data set (163), respectively, depicted in FIG. 1A above. In one or more embodiments of the invention, one or more of the modules and elements shown in FIG. 1B may be omitted, repeated, and/or substituted. Accordingly, embodiments of the invention should not be considered limited to the specific arrangements of modules shown in FIG. 1B.

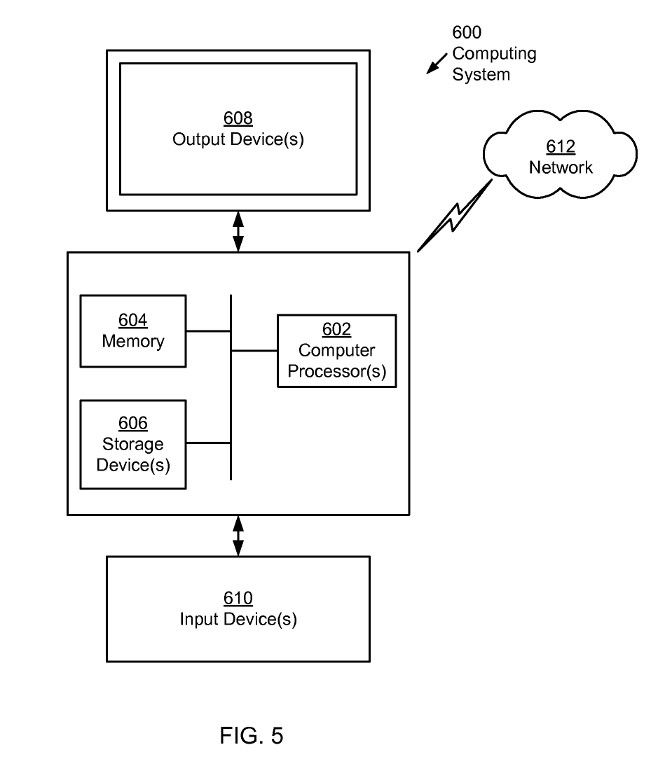

In one or more embodiments of the invention, the global textsite platform (108) executes on one or more computing device(s) (e.g., a server, a computer system as shown in FIG. 5 and described below, etc.) and may be hosted by an entity, such as a corporation. In one or more embodiments of the invention, the global textsite platform (108) is associated with a platform syntax that is specific to the global textsite platform (108) and facilitates communication via a TMS. In one or more embodiments of the invention, the global textsite platform (108) may be associated with different unique phone numbers or codes corresponding to each different geographic location. Alternatively, a single, unique global number/code may be associated with the global textsite platform (108). In one or more embodiments of the invention, the global textsite platform (108) includes a repository (110) for storing keywords (112), a server (116) configured to host a plurality of textsites (e.g., textsite (118a)), an agent (115), and an adaptor (120). Those skilled in the art will appreciate that the server (116) may be any computing device with a large storage capacity.

The repository (110) may be any datastore (flat file, hierarchical file, relational database, enterprise-wide database, etc.) capable of storing data, regardless where or in what form the data originates. Keywords (112) may be reserved or pre-designated keywords maintained by the platform as part of the platform syntax, and publisher keywords that are registered by publishers for each textsite authored by a publisher. In one or more embodiments of the invention, pre-designated keywords and publisher registered keywords are unique. That is, no two keywords from the group of keywords that are pre-designated as platform syntax or the group of keywords provided by a publisher, are allowed to be identical. In fact, in one or more embodiments of the invention, the keywords (112) are closely controlled by the global textsite platform (108) in an effort to eliminate duplicates. Navigating keywords, which a publisher defines for a textsite that is associated with a unique registered keyword, are also used. Navigating keywords are not required to be unique. For example, two distinct publishers with distinct registered keywords representing a first and a second textsite may use the same navigating keyword for different text pages associated with the first and second textsites.

In one or more embodiments, a portion of the keywords (112) is organized as a registry (113) storing a number of registered unique keywords each used as a site identifier and associated with metadata describing a mechanism for accessing corresponding site content, such as content stored in the textsite (118a), etc. In one or more embodiments, the registered unique keywords (i.e., used as site identifiers) are registered by textsite content publishers with relevant information processed into associated metadata. In one or more embodiments, the textsite (118a) may be hosted by the global textsite platform (108) on behalf of a first publisher or may be an in-house textsite maintained by the global textsite platform (108). In such embodiments, the metadata associated with the registered unique keyword (i.e., used as site identifiers) includes an internal link to the textsite (118a) within the global textsite platform (108).

In one or more embodiments, the textsite (128a) is published by a second publisher that has registered with the global textsite platform (108) but is hosted on a separate third party server (126a). In such embodiments, the metadata associated with the registered unique keyword (i.e., used as site identifier) includes an access path for the global textsite platform (108) to access the third party server (126a) via the telecommunication network (130) and/or the Internet (126). In one or more embodiments, the third party server (126a) may include agent (130a) configured with similar functionalities as those of the agent (115). For example, the agent (130a) may be provided to an operator of the third party server (126a) by an operator of the GTP (108) under a pre-determined business agreement (e.g., a licensing agreement).

In one or more embodiments, contents of the website (138) are converted by the global textsite platform (108) to be accessible to a user via TMS. In such embodiments, the metadata associated with the registered unique keyword includes an access path for the global textsite platform (108) to access the web server (136) via the Internet (126) and identifies whether the contents of the website (138), or a portion thereof, are converted dynamically (i.e., on demand) or statically (i.e., pre-converted and stored).

Generally, a publisher may be any person or entity that publishes information/content of a textsite (e.g., textsite (118a)) for users to access via a text messaging service or other network service. More specifically, a publisher may be any developer or service provider that provides a service or a product for users. For example, a publisher may be a restaurant owner that creates a textsite to provide information about his/her restaurant.

In one or more embodiments, a user is defined as a person or entity accessing content published by publishers and registered with the global textsite platform (108). As noted above, the published and registered content may be hosted by the global textsite platform (108). In one or more embodiments, a user is a person or entity with a mobile device that does not have a data plan subscription. Rather, the user is able to obtain data using the mobile device only via a TMS. That is, embodiments of the invention pertain specifically to users accessing content only via a TMS. Those skilled in the art will appreciate, however, that although embodiments of the invention target users that communicate via a TMS, the invention is not limited to such users. Specifically, while embodiments of the invention are directed to providing access to textsites to users using a mobile phone via a TMS, some users may be provided with the capability to access content on the global textsite platform (108) via a computing device (128), such as a desktop computer, a laptop computer, a thin computer, a combination thereof, or any other suitable electronic computing device that is capable of connecting to the global textsite platform (108) via the Internet (126). For example, in one or more embodiments, a user may use a text message emulator executing on the computing device (128) to connect to the global textsite platform (108) via the Internet (126). Alternatively, users with smart phones and/or mobile devices that support Internet browsing functionality could access content on the global textsite platform (108) using the Internet (126).

Further as shown in FIG. 1B, a user may possess the user mobile device (102) that is communicatively coupled to the global textsite platform (108) via the telecommunication network (130) and the Internet (126). The user mobile device (102) includes a display (104), a microchip (105), and a TMS input/output module (106). The user mobile device (102) may be any mobile device, such as a Code Division Multiple Access (CDMA) device, a global system mobile (GSM) device, a 3G device, a 4G device, a smart phone, a tablet, a pad device, a gaming device, a personal digital assistant, or any other suitable mobile device that includes text messaging functionality. In one or more embodiments of the invention, the user mobile device (102) is operatively connected to a global textsite platform (108) via a telecommunication network (130). The telecommunication network (130) may be any network that facilitates the exchange of messages from one part of the network to another. For example, the telecommunication network (130) may be a wide area network, a local area network, a public switched telephone network (PSTN), or any other suitable network for exchanging messages between the global textsite platform (108) and the user mobile device (102).

The display (104) of the user mobile device (102) may be a display screen using technology such as liquid crystal display (LCD), a light emitting diode (LED), organic light emitting diode (OLED), or any other suitable type of display screen capable of displaying the content of received text messages and the content of a text message that is being composed on the user mobile device (102). The microchip (105) may be any tangible hardware processor(s) or microprocessor(s) for executing the functionalities of the user mobile device (102). More specifically, the microchip (105) executes the software application(s) that provide functionalities such as browsing, text messaging, maintaining a contact list and making phone calls, etc. The TMS input/output module (106) may be a virtual keyboard, a physical keyboard, or any other input/output device(s) or button(s) that allows the publisher to compose text messages and receive and read text message responses.

In the user system (100b) of FIG. 1B, the global textsite platform (108) is configured to receive a text message from the user mobile device (102) that includes a request to access a textsite hosted by the global textsite platform (108). Further, the global textsite platform (108) is configured to process the request received from the user mobile device (102), and to provide the content from the desired textsite to the user's mobile device (102) via a TMS.

To facilitate this interaction with a user mobile device (102), the global textsite platform (108) includes an agent (115). In one or more embodiments of the invention, the agent (115) may be software that is the component of the global textsite platform (108), which communicates with a user mobile device (102). Specifically, the agent (115) is configured with functionality to receive a text message (i.e., a user message) from a user mobile device (102), parse the text message for the relevant keywords or platform-specific syntax, and respond to the user request by identifying and retrieving the content from the requested textsite/converted website for delivering back to the user mobile device (102) in accordance with one or more embodiments of the invention. In one or more embodiments, the content is delivered to the user mobile device (102) in a text message sent from the global textsite platform (i.e., a GTP message).

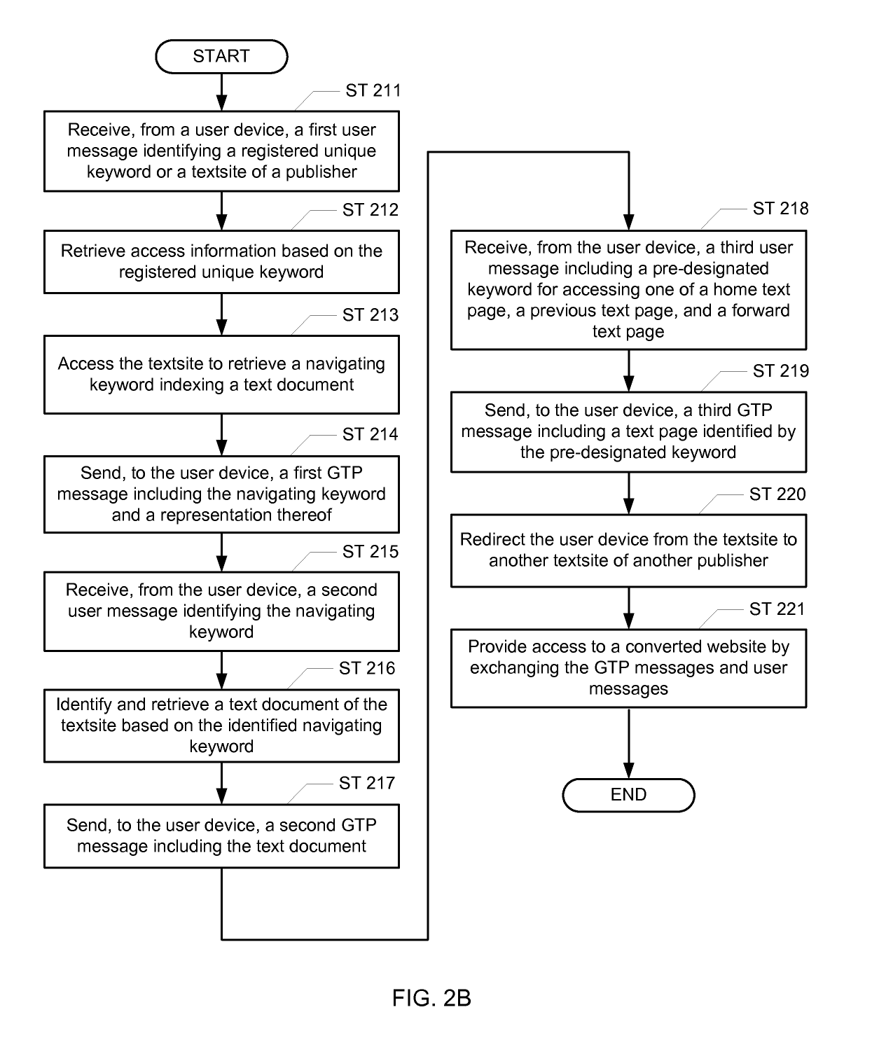

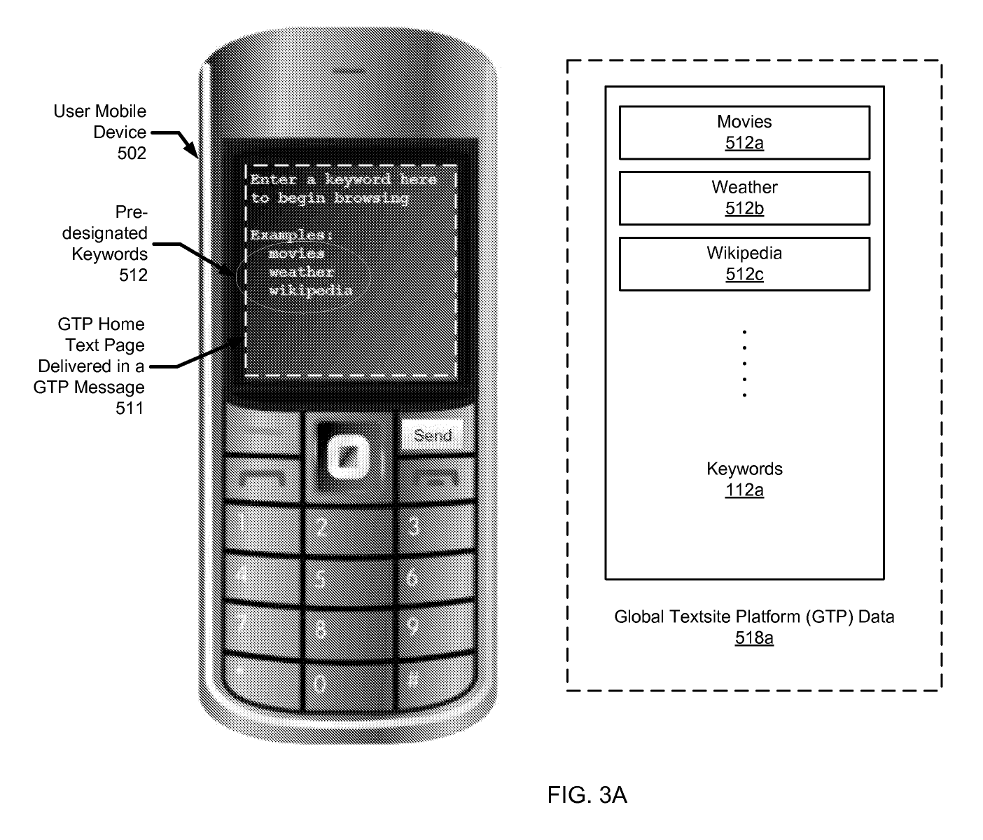

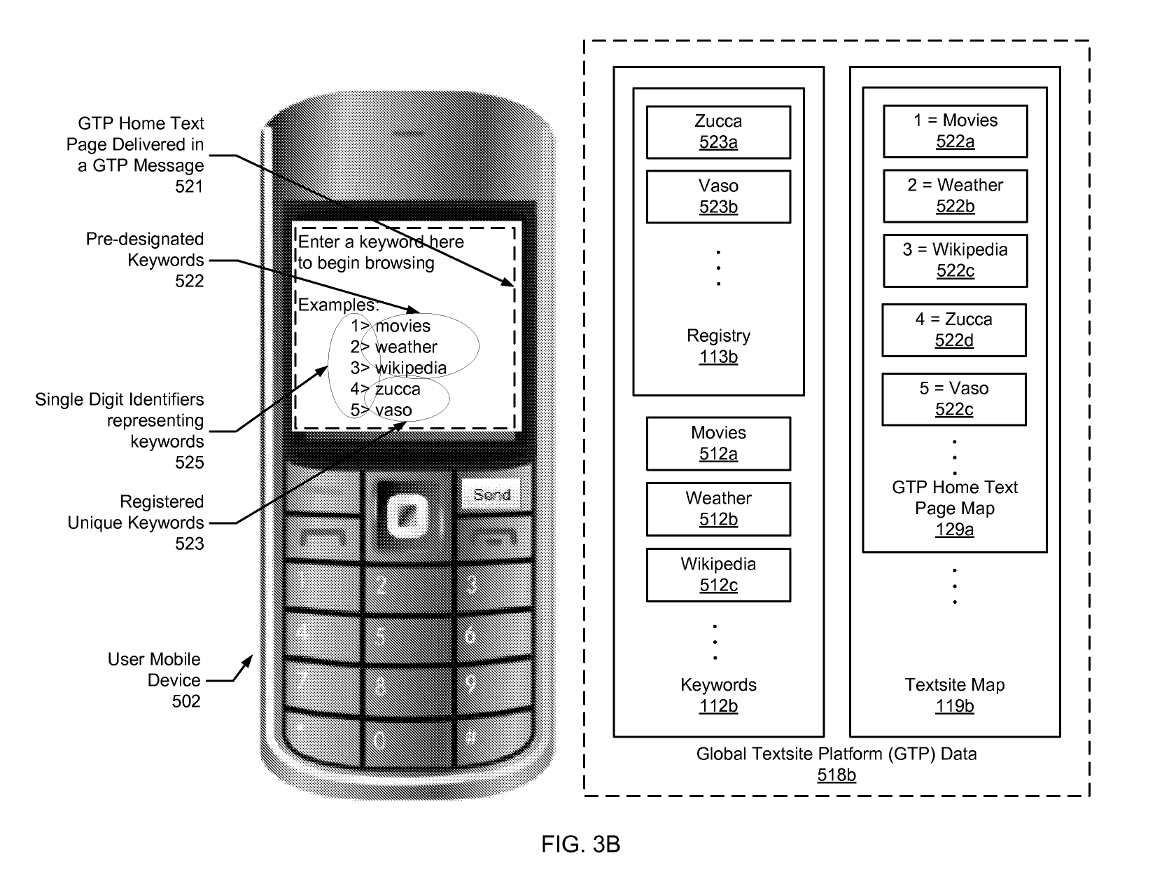

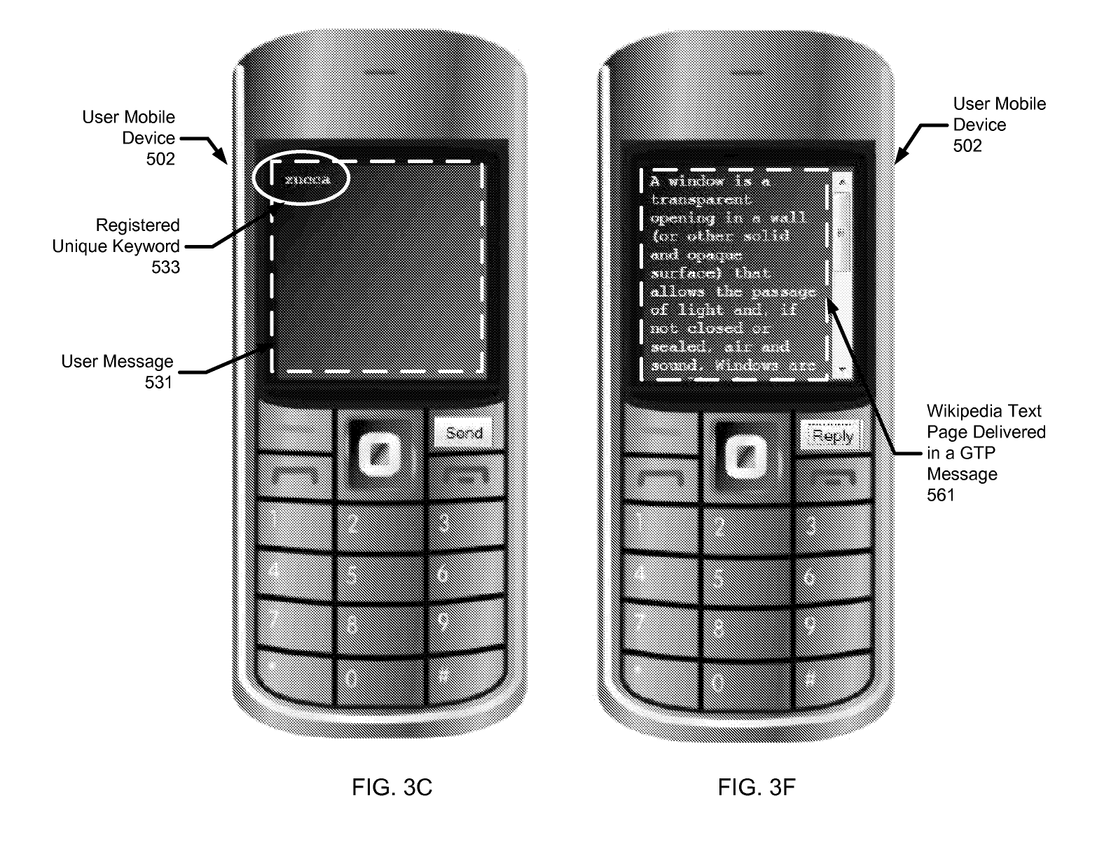

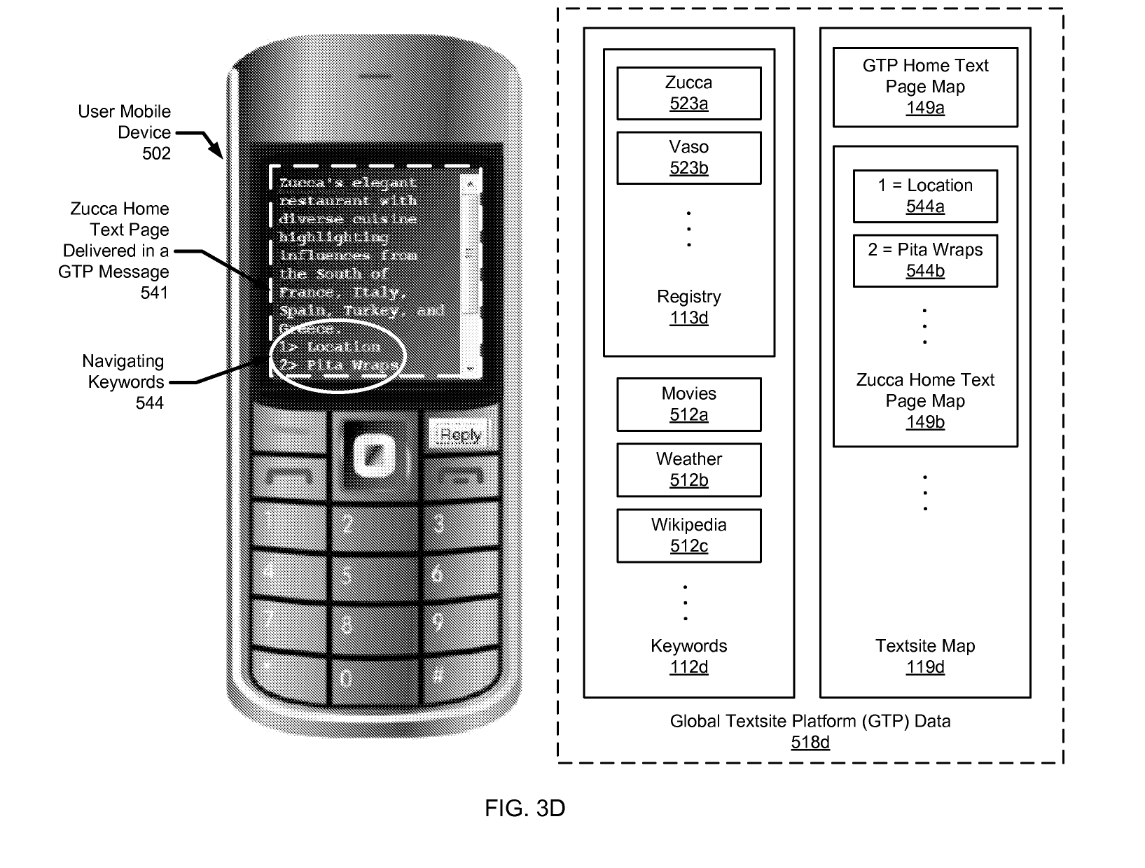

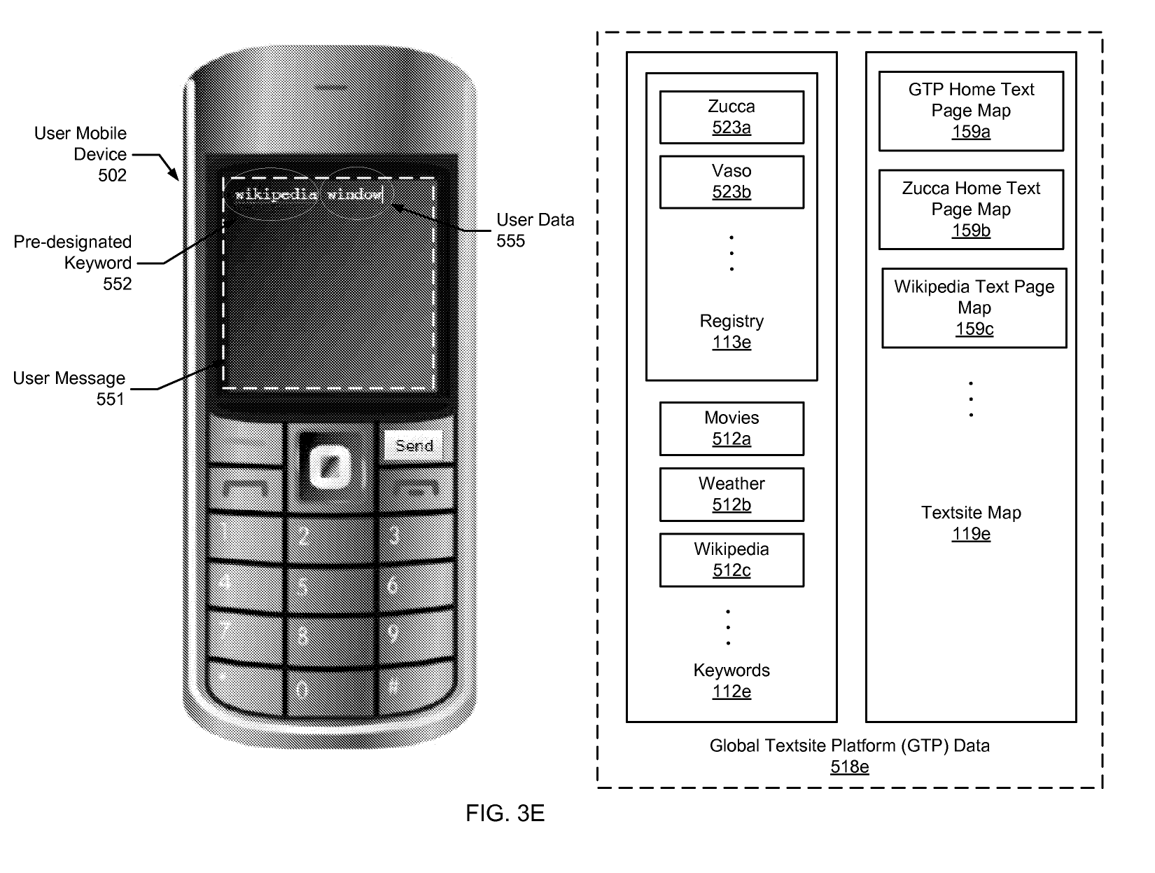

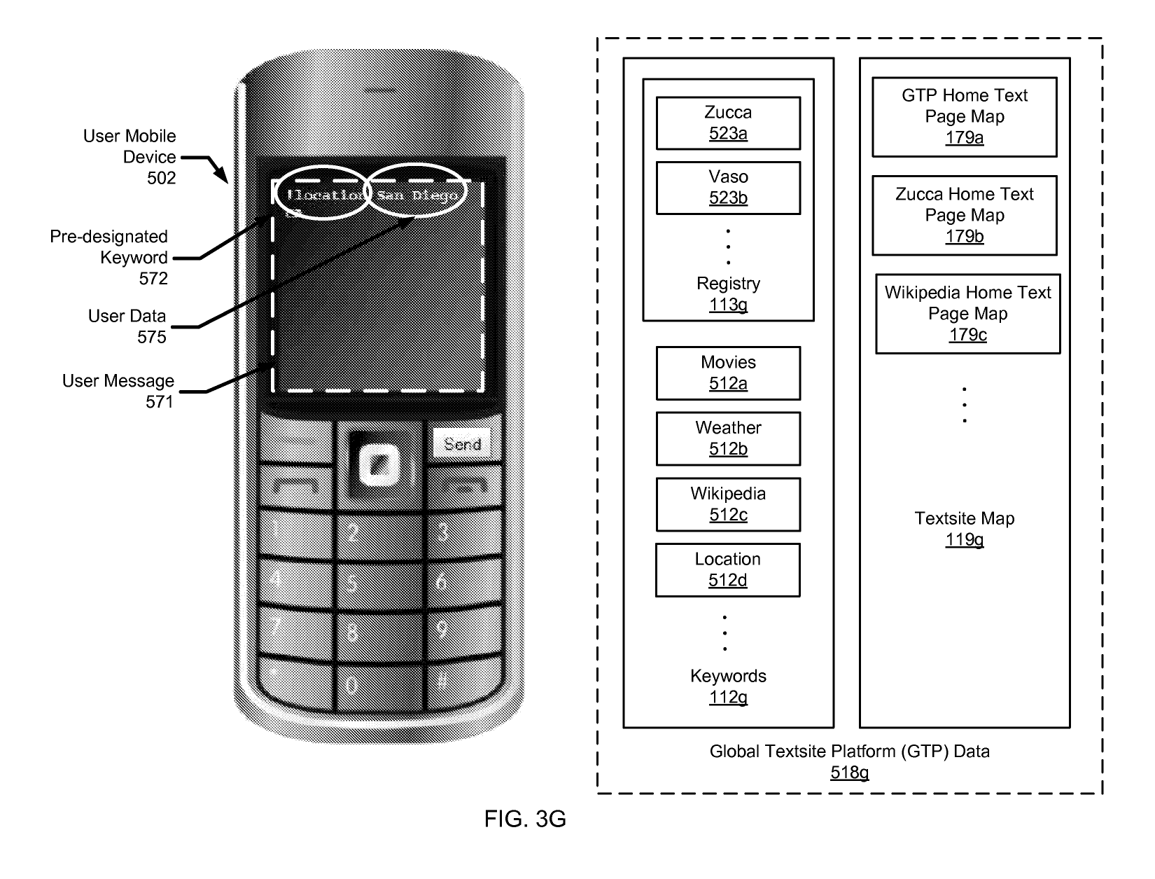

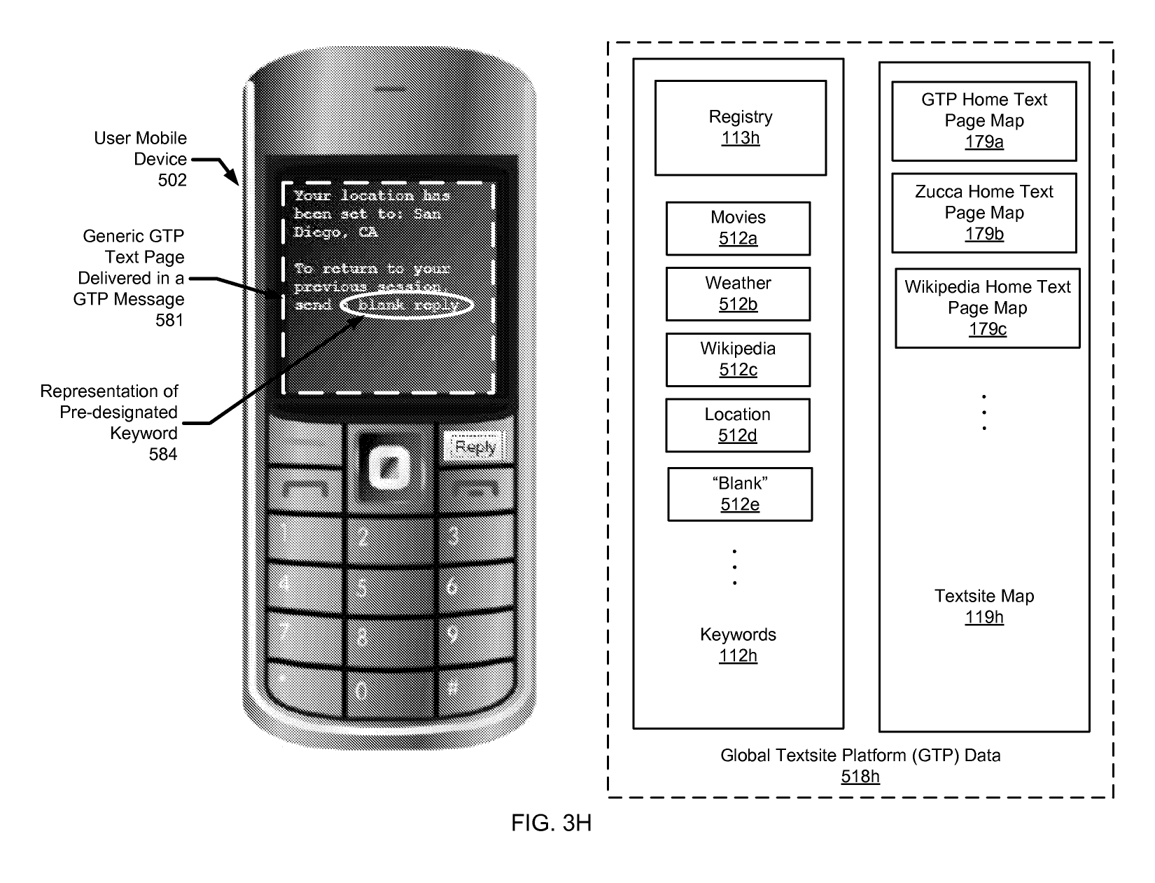

In one or more embodiments of the invention, the agent (115) is configured to identify, based on the registry (113), a registered unique keyword (i.e., used as site identifier) in the user message as a request to access the textsite (118a) hosted on the global textsite platform (108) or the textsite (128a) hosted on the third party server (126a). Accordingly, the agent (115) is configured to access the textsite (118a) or the textsite (128a) using the aforementioned access path included in the associated metadata. In one or more embodiments, the agent (115) is configured to exchange text messages with the user mobile device (102) for navigating a text page hierarchy of the textsite (118a) or the textsite (128a). In one or more embodiments, the textsite (118a) and the textsite (128a) include textsite map (119) and textsite map (129), respectively, that describe the hierarchical relationships of text pages contained within each textsite (118a, 128). For example, the textsite map (119) and the textsite map (129) may each include a data structure (e.g., graph, tree, linked list, file, database, etc.) containing navigating keywords defined by the respective publisher. Generally speaking, navigating keyword information (e.g., access information such as location, address, or other information enabling access to a text page pointed to by a navigating keyword) and navigation paths among text pages in the textsite (e.g., textsite (118a)) are stored in the textsite map (e.g., textsite map (129)). Specifically, a navigation path leads from one text page to another via intervening text pages accessed using the navigating keywords contained in each of the text pages traversed along the navigation path. More details of navigating a textsite, for example based on the textsite map, by exchanging text messages between the agent (115) and the user mobile device (102), are described in reference to FIGS. 3A-3J below.

In one or more embodiments of the invention, the agent (115) is configured to identify, based on the registry (113), a registered unique keyword (i.e., used as site identifier) in the user message as a request to access the website (138) hosted on the web server (136). For example, such registered unique keyword may be registered by a publisher of an adaptor plug-in that maps the website map (139) into a global textsite platform syntax suitable for the adaptor (120) to convert contents of the website (138). Accordingly, the agent (115) is configured to activate the adaptor (120) for accessing the website (138) using the aforementioned access path included in the associated metadata. In one or more embodiments, the agent (115) is configured to exchange text messages with the user mobile device (102) and convert between such text messages in the global textsite platform syntax (e.g., navigating keywords) and the website map (139) for navigating a website document hierarchy of the website (138). For example, the mapping between such navigating keywords and the website map (139) may be contained in an adaptor plug-in for the website (138) where the navigating keywords are defined by the publisher of the adaptor plug-in.

In one or more embodiments of the invention, the agent (115) is configured to identify a web URL (i.e., used as website identifier in Universal Resource Locator format) in the user message as a request to access the website (138) hosted on the web server (136). Accordingly, the agent (115) is configured to activate the adaptor (120) for accessing the website (138) using the identified web URL via the Internet (126). The subsequent navigation of the website (138) may be essentially the same as described above.

In one or more embodiments of the invention, the textsite (118a), the textsite (128a), and/or the website (138) are configured to integrate contents from each other. In such embodiments, the textsite map (119), the textsite map (129), and/or the website map (139) are configured to include registered unique keywords (i.e., used as site identifiers) of other textsites and/or websites, which may be included in user text messages for redirecting the user mobile device (102) from one site (e.g., one of the textsite (118a), the textsite (128a), and the website (138)) to another during navigation of textsite content or converted website content.

In one or more embodiments of the invention, the aforementioned text messages exchanged between the user mobile device (102) and the global textsite platform (108), and more specifically between the user mobile device (102) and the agent (115), are of the same TMS protocol. Alternatively, text messages exchanged may include more than one TMS protocol. For example, the user messages may be SMS and the GTP messages may be MMS. Additional combinations are also possible in other examples.

Although the description above uses the user mobile device (102) in various example embodiments, those skilled in the art will appreciate that similar functionalities may be achieved by substituting the user mobile device (102) with the computing device (128). Further, the aforementioned redirecting functionality may be adapted to allow browsing of website (138) using the computing device (128) to be redirected to accessing a textsite (e.g., textsite (118a) or textsite (128a)) using the user mobile device (102) and vice-versa.

Although the GTP data (e.g., keywords, registry, textsite map, etc.) shown in FIG. 1B above are described in specific formats and organizations, those skilled in the art with the benefit of this disclosure will recognize that GTP data may be in other formats or organizations without deviating from the spirit of the invention.

FIG. 2A shows a flow chart for using TMS protocol, or other network protocol requiring a data plan, during an application session in accordance with one or more embodiments of the invention. More specifically, FIG. 2A shows a flow chart describing validating TMS messages, and presenting information contained therein, subsequent to substituting another network protocol (e.g., where bandwidth usage is subject to data plan charges) by the TMS protocol during the application session. Specifically, the application session includes a sequence of activities (e.g., requests and responses) performed by an application between a user client device and a computing platform providing the content. In one or more embodiments of the invention, the method of FIG. 2A may be practiced using the system (100a) described in reference to FIG. 1A above. In one or more embodiments of the invention, one or more of the steps shown in FIG. 2A may be omitted, repeated, and/or performed in a different order than that shown in FIG. 2A. Accordingly, the specific arrangement of steps shown in FIG. 2A should not be construed as limiting the scope of the invention.

In one or more embodiments, the application of the application session is a client server application. In one or more embodiments, the user client device is a mobile device (e.g., a smartphone) and the component of the client server application that executes on the mobile device is a mobile application. In one or more embodiments, the mobile application accesses content provided by a computing platform during the application session. In one or more embodiments, the computing platform includes a computer server hosting a website and a global textsite platform (GTP) hosting a textsite. For example, the mobile device may access the content from the website and/or the textsite.

Initially in ST 201, during the application session, an instruction is received by the user client device to switch from using a network communication protocol to a text messaging service (TMS) protocol for data communication of the application session. In one or more embodiments, bandwidth usage of the network communication protocol is subject to data plan charges levied by a network service provider, such as a cellular phone network service provider. In such embodiments, the instruction may be issued by the user to conserve the bandwidth usage metered according to the data plan. In one or more embodiments, the instruction is automatically issued in response to detecting a connection loss of the network communication protocol.

In ST 202, subsequent to receiving the instruction during the application session, a text identifier associated with a UI data item of the UI is sent by the user client device using the TMS protocol to the GTP. In one or more embodiments, the UI data item is for requesting a portion of the content from the computer server when the network communication protocol is used for the client server application session. Specifically, the text identifier is sent in place of the UI data item since the network communication protocol is substituted by the TMS protocol according to the instruction.

In one or more embodiments, the GTP stores a text based copy (e.g., the aforementioned textsite) mirroring the content (e.g., the aforementioned website) stored on the computer server. In particular, the requested portion (e.g., a webpage) of the content referenced by the UI data item corresponds to a text page in the text based copy (e.g., textsite). For example, the UI data item is a reference to the requested portion of the content, such as a URL or a hyperlink referencing the webpage, while the text page is referenced by a navigating keyword of the textsite. In one or more embodiments, the text identifier is a short hand identifier of the navigating keyword. In one or more embodiments, the text identifier is assigned to represent the navigating keyword by the user client device based on a pre-determined rule. Accordingly, the text identifier is inserted into a TMS message composed by the user and sent by the user client device to the GTP. Using the short hand identifier reduces the amount of key clicks for the user to compose the TMS message and also makes it easier to keep the length of the TMS message under a TMS imposed maximum text character count limitation. In one or more embodiments, when the text identifier is assigned by the user client device, the TMS message also includes information regarding the association (i.e., mapping) between the text identifier and the navigating keyword. Accordingly, the GTP can parse the TMS message and convert the text identifier back to the navigating keyword for retrieving the text page that corresponds to the requested portion of the content.

In one or more embodiments, the website is pre-converted to the textsite. In other words, the webpage of the website is pre-converted to the text page in the textsite. The conversion specifies the mapping between the webpage references (i.e., the UI data item) and the text page references (i.e., the navigating keyword). Accordingly, the webpages and text pages can be cross referenced based on this mapping. In particular, the webpage referenced by the UI data item contains the equivalent information as the text page referenced by the navigating keyword. In one or more embodiments, the GTP identifies the navigating keyword based on the text identifier in the TMS message. The text page is then retrieved from the textsite based on the navigating keyword for sending to the user client device.

In one or more embodiments, the website is dynamically converted to the textsite. In other words, the webpage of the website is converted on demand to the text page in the textsite. In one or more embodiments, the GTP converts the text identifier (via the corresponding navigating keyword) back to the UI data item (e.g., webpage link) for sending to the computer server. The computer server in turn retrieves the requested portion of the content (e.g., webpage) based on the UI data item (e.g., webpage link) for returning to the GTP. Accordingly, the GTP dynamically converts the portion of the content (e.g., webpage) into the text page for sending back to the user client device using the TMS protocol.

In ST 203, the text page is received by the user client device using the TMS protocol. In one or more embodiments, the text page is included in one or more TMS message sent from the GTP. In one or more embodiments, the TMS message containing the text page also includes a validation code derived from the text identifier. Specifically, the validation code is used to identify TMS messages related to the text identifier, for example during a single request/response transaction between the user client device and the GTP.

In ST 204, the TMS message is validated based on the validation code and a sender phone number of the TMS message. For example, the sender phone number or information representing the sender phone number may be embedded in header information of the TMS message. In one or more embodiments, the TMS message is validated to ensure that it is related to the application session. For example, that the TMS message is not sent by other entity different than the intended GTP. Further, the validation code ensures that the received TMS message is intended for the text identifier associated with the particular UI data item, instead of being intended for any other concurrently pending text identifier sent by the user client device during the application session.

In ST 205, the text page is extracted from the TMS message in response to validating the TMS message. Accordingly, the text page is presented to the user in ST 206. In one or more embodiments, a user interface (UI) is used for presenting the content returned by the computing platform to the user inside/outside the application when the network communication protocol is used for the application session. In one or more embodiments, the same UI is used to present the extracted text page subsequent to switching to the TMS protocol. In one or more embodiments, a different UI is used to present the extracted text page subsequent to switching to the TMS protocol. Examples of the UIs are described in reference to FIGS. 4A-4H below.

FIG. 2B shows a flow chart for accessing content of one or more textsites in accordance with one or more embodiments of the invention. More specifically, FIG. 2B shows a flow chart describing the process for accessing content from the global textsite platform (GTP) perspective, in which the platform provides users (i.e., users accessing content authored by publishers) with access to content maintained in the form of textsites by the GTP. In one or more embodiments of the invention, the method of FIG. 2B may be practiced using the GTP described in reference to FIG. 1B above. In one or more embodiments of the invention, one or more of the steps shown in FIG. 2B may be omitted, repeated, and/or performed in a different order than that shown in FIG. 2B. Accordingly, the specific arrangement of steps shown in FIG. 2B should not be construed as limiting the scope of the invention.

Initially in ST 211, a first user message is received, from a user mobile device that identifies a registered unique keyword maintained by the GTP. As described above, the registered unique keyword may be registered with the GTP by a publisher of a textsite identified by the registered unique keyword while the user device may be a mobile phone or other computing devices. By sending the registered unique keyword in the first user message, the user is requesting access to (i.e., to browse) the textsite associated with the registered unique keyword. In one or more embodiments of the invention, the GTP and/or the publisher may distribute an advertisement containing the registered unique keyword in a commercial promotion. Accordingly, the user may obtain the registered unique keyword from the advertisement. Alternatively, in one or more embodiments of the invention, the GTP may send, in response to receiving a request from the user device, a GTP message identifying a number of sample registered unique keywords from which the user may select a particular one to be included in the first user message. For example, the sample registered unique keywords may be registered with the GTP by a number of different publishers. In one or more embodiments, the request for a listing of registered unique keywords may be received from the user device in a second user message containing a pre-designated keyword defined specifically for requesting such a listing. Alternatively, in one or more embodiments, the user may request such a listing by simply making a conversationless call to the phone number of the GTP instead of sending the second user message to the same phone number. Using any of the approaches described above, the user may obtain a list of textsites accessible via the GTP using a single phone number (e.g., a local phone number) provided by the GTP according to a geographical location of the user. Accordingly, the user is not required to separately obtain and keep different phone numbers for accessing different textsites using a TMS.

In ST 212, authored content (e.g., access information) associated with the textsite requested by the user is retrieved based on the registered unique keyword extracted from the first user message received at the GTP. In one or more embodiments of the invention, the GTP maintains a registry containing an entry for each registered unique keyword that holds pertinent information of the textsite such as location, network address, access path, and other suitable metadata associated with the textsite. Accordingly, the access information associated with the user requested textsite may be retrieved. For example, such access information may determine whether the requested textsite is hosted on a server of the GTP or a third party server separate from the GTP.

In ST 213, the textsite is accessed based on the retrieved authored content (e.g., access information) to retrieve a navigating keyword. For example, a portion of the navigating keywords of the textsite may be retrieved. In another example, the navigating keyword may be retrieved by retrieving a home text page from the textsite that contains the navigating keyword. Generally speaking, the navigating keyword may be an alphanumeric string (e.g., location, Pita Wraps, Panini, Entrees, etc.) that is meaningful to the user but requires many keys to enter into the user device while the other navigating keyword may be a short string (e.g., loc, PW, P, E, 1, 2, 3, etc.) that is easy to enter but less meaningful to the user for selection. To assist the user in selecting a navigating keyword from a GTP message and to key in the selected navigating keyword when composing a reply user message, a cryptic navigating keyword (e.g., loc, PW, P, E, 1, 2, 3, etc.) may be associated with a meaningful label (e.g., location, Pita Wraps, Panini, Entry, etc.) and displayed together (e.g., loc>location, PW>Pita Wraps, P>Panini, E>Entrees, 1>location, 2>Pita Wraps, 3>Panini, etc.) in the text page delivered via the GTP message. Similarly, a meaningful navigating keyword (e.g., location, Pita Wraps, Panini, Entry, etc.) may be associated with a short hand identifier (e.g., loc, PW, P, E, 1, 2, 3, etc.) and displayed together (e.g., loc>location, PW>Pita Wraps, P>Panini, E>Entrees, 1>location, 2>Pita Wraps, 3>Panini, etc.) in the text page delivered via the GTP message. The meaningful label and the short hand identifier are referred to as a representation of the navigating keyword. In one or more embodiments, representations of the navigating keyword may also include formats different from the meaningful label and/or the short hand identifier.

In ST 214, a first GTP message containing the retrieved navigating keyword is sent to the user device in response to receiving the first user message. In one or more embodiments, the first GTP message includes the retrieved portion of the textsite navigating keywords. In one or more embodiments, the first GTP message includes the text page containing the retrieved navigating keyword. For example, the home text page of the textsite may be sent to the user device in the first GTP message as a reply to the first user message containing the registered unique keyword. Accordingly, the user may access a desired text page from the home text page by selecting a corresponding navigating keyword contained in the home text page. In one or more embodiments, a text page also contains, as defined by the publisher, representations of included navigating keywords for ease of user selection. For example, each of the navigating keywords in the home text page sent in the first GDP message may be accompanied by a meaningful label or a short hand identifier. Accordingly, the user may specify (or identify) a desired text page by including either a corresponding navigating keyword or a representation of such navigating keyword in a second user message replying to the first GTP message. In ST215, this second user message is received at the GTP.

As noted above, navigating keyword information (e.g., access information such as location, address, or other information enabling access to a text page pointed to by a navigating keyword) and navigation paths to text pages in the textsite are stored in the textsite map. In one or more embodiments of the invention, information regarding meaningful labels, short hand identifiers, or other keyword representations for a navigating keyword in a text page is also included in the textsite map. For example, such information includes the aforementioned dynamically assigned link and dynamically assigned keyword identifier described in reference to FIGS. 1A and 2A above. In ST 216, the desired text page is identified according to the textsite map based on either the navigating keyword or a representation (e.g., a meaningful label, short hand identifier) thereof extracted from the second user message. Further, the desired text page is retrieved by looking up access information in the textsite map accordingly.

In ST 217, the desired text page is included in a second GTP message and sent, as reply to the second user message, to the device for display to the user.

In ST 218, a third user message is received from the device while displaying the first text page. The third user message includes a pre-designated keyword (e.g., “,” “0,” “.,” etc.). For example, the pre-designated keyword may be defined specifically for accessing a home text page of the textsite. In response, the GTP sends the home text page to the device in a third GTP message (ST 219). In another example, the pre-designated keyword may be defined specifically for accessing a previous text page sent to the device prior to the text page in a navigation trace. An example navigation trace is described with reference to FIGS. 3A-3J below. In response, the GTP sends the previous text page to the device in the third GTP message (ST 219). In still another example, the pre-designated keyword may be defined specifically for accessing a forward text page sent to the device subsequent to the text page in the navigation trace. In response, the GTP sends the forward text page to the device in a third GTP message (ST 219). In yet another example, the pre-designated keyword may be defined specifically for subscribing to updates of a currently displayed text page. In response, the GTP sends updated versions of the currently displayed text page in a push mode to the device from time to time in recurring GTP messages (ST 219).

While the description above regarding ST 211 through ST 219 relates to a textsite published by a publisher under a registered unique keyword, the user may obtain another registered unique keyword separately registered with the GTP by another publisher of another textsite. During navigation of the currently displayed textsite, a user message may be received identifying a second registered unique keyword. For example, such user message may include either the second registered unique keyword or a representation thereof. In response, the GTP redirects the user device from the currently navigated textsite to the second textsite (ST 220). Accordingly, the GTP may exchange text messages with the device for navigating the second textsite using a second set of navigating keywords according to a second textsite map of the second textsite. Accordingly, in one or more embodiments, the user may switch back and forth between different textsites published by different publishers without the need to change the phone number to which the text messages are sent in the middle of the textsite navigation.

As described above, there are several different approaches as to how a user may obtain a list of all textsites accessible via the GTP regardless of which publisher authored the content. An additional scenario in which the user may obtain additional registered unique keywords is from a text page having an embedded external link, as authored by the publisher and is consistent with the textsite map. In this scenario, a user message may be redirected to a second or third textsite as described above. Further, the text page may include a short hand identifier for the embedded external link in which case the user message may just include the short hand identifier for quick redirection.

In some scenarios, the second textsite described above is converted from a website, for example, using the adaptor described in reference to FIG. 1B above. In such scenarios, the second navigating keyword may be registered for the website where a corresponding registry entry specifies a particular adaptor plug-in for use to map between a website map of the website and a textsite map converted from the website map. Specifically, a navigating keyword received in a user message during navigation of the converted website is processed using the textsite map, the adaptor plug-in, and the website map to retrieve access information associated with a corresponding webpage. Subsequently, the webpage may be retrieved and converted dynamically (i.e., on demand) into a text page for sending to the user device. Alternatively, a pre-converted text page may be stored and retrieved for sending to the user device (ST 221).

Although the description above with respect to FIGS. 3A through 3J generally refers to messages exchanged between the GTP and the user device as text messages transmitted via TMS, those skilled in the art with the benefit of this disclosure will appreciate that the invention is not intended to be limited to exchanges exclusively in text messages or using a TMS. For example, the GTP may provide functionalities to allow a user switching back and forth between browsing textsites via Internet using a computing device and navigating the textsites via telecommunication network using a mobile phone in a seamless fashion with uninterrupted handovers.

Examples of screenshots detailing what a user text message and a response from the global textsite platform may look like are described in reference to FIGS. 3A-3J below.

FIGS. 3A-3J show various screenshots illustrating examples of accessing content hosted by a global textsite platform in one or more embodiments of the invention. Although FIGS. 3A-3J show implementation examples of embodiments of the invention, those skilled in the art will appreciate that there may be other ways in which to implement embodiments of the invention, and that the example screenshots are not meant to limit the scope of the invention. Throughout FIGS. 3A-3J, a text page delivered in a GTP message and the GTP message delivering the text page may both be referred to using the same reference numerals.

FIG. 3A shows the user mobile device (502) displaying an example GTP home text page, which is delivered via TMS in a GTP message (511). As noted above, this GTP home text page may be sent in the GTP message (511) in response to a request from a user. For example, the user may send a request message in a pre-designated format (e.g., with blank content or with content associated with another pre-designated keyword) using a phone number of the GTP to request the GTP home text page. In another example, the user may have made a conversationless telephone call to the phone number of the GTP to request the GTP home text page. As shown in FIG. 3A, the GTP home text page includes pre-designated keywords (512) listed as movies, weather, and Wikipedia. For example, these pre-designated keywords are stored in the keywords (112a) of GTP data (518a) corresponding to the keywords (112) shown in FIG. 1B above. The keywords (112a) includes pre-designated keyword entries of movies (512a), weather (512b), and Wikipedia (512c) corresponding to sample textsites or generic textsites included in and/or hosted by the GTP.

FIG. 3B shows the user mobile device (502) displaying another example GTP home text page delivered in a GTP message (521), which may be requested and delivered in essentially the same way as the example GTP home text page described in reference to FIG. 3A above. In the example GTP home text page shown in FIG. 3B, the pre-designated keywords (522) are essentially the same as the pre-designated keywords (512) described above while followed by registered unique keywords (523) listed as zucca and vaso. Accordingly, keywords (112b) of the GTP data (518b) include a registry (113b) in addition to the pre-designated keyword entries movies (512a), weather (512b), and wikipedia (512c). As shown, the registry (113b) includes keyword entries zucca (523a) and vaso (523b), which are linked to access information (not shown) to the respective textsites associated with those keywords.

Further as shown in FIG. 3B, short hand identifiers (525) (i.e., 1, 2, 3, 4, and 5) are displayed next to and represent pre-designated keywords (522) and registered unique keywords (523) for user selection in the example GTP home text page delivered in the GTP message (521). For example, zucca and vaso of the registered unique keywords (523) correspond to a restaurant textsite and a bookstore textsite, respectively. As described above, the user may include either the keyword “zucca” or the corresponding short hand identifier “4” when replying to the GTP message (521) to access the restaurant textsite. To facilitate this, a textsite map (119b) of the GTP data (518b) includes GTP home text page map (129a) containing entries (e.g., entry (522a) through entry (522e), etc.) for describing representations of the keywords using the short hand identifiers (525) and for describing access information authored for the respective textsites.

As described above, the registered unique keywords zucca and vaso may be registered with the GTP by the respective restaurant and bookstore owners who created their own textsites or registered by contracted publishers on their behalf. Further, the zucca textsite may be hosted on a server of the GTP while the vaso textsite may be hosted on a third party server separate from the GTP.

FIG. 3C shows the user mobile device (502) displaying an example user message (531) containing the registered unique keyword (533) (i.e., zucca) as selected by the user from the example GTP home text page shown in FIG. 3B above. Alternatively, the registered unique keyword (533) may be obtained by the user from an advertisement distributed, for example, by restaurant zucca in a commercial promotion.

FIG. 3D shows the user mobile device (502) displaying an example home text page of the textsite for restaurant Zucca, which is delivered in a GTP message (541) in response to the user message (531) described above. As shown, the example zucca home text page includes navigating keywords and representations thereof (544) listed as “1>location” and “2>pita wraps.” For example, “1” may be considered the navigating keyword while “location” is the meaningful label. Alternatively, “location” may be considered the navigating keyword while “1” is the short hand identifier. In either case, the aforementioned navigating keywords and representations thereof are displayed together for user selection in the zucca home text page. In the example shown in FIG. 3D, the GTP data (518d) is essentially the same as the GTP data (518b) shown in FIG. 3B above with an additional zucca home text page map (e.g., entry (544a), entry (544b), etc.) included in the textsite map (119d). For example, the GTP home text page map (149a) is essentially the same as the GTP home text page map (129a) shown in FIG. 3B above. As described above, the zucca home text page map (149b) contains entries for describing representations of the navigating keywords using the meaningful labels or short hand identifiers within the zucca home text page and for describing access information for respective text pages referenced by the navigating keywords. For example, including either the navigating keyword or the corresponding representation (i.e., either one of “location” or “1”) in a user message replying to the GTP message (541) results in a text page containing address and driving direction information of the zucca restaurant being identified by the GTP. The address and driving direction information (i.e., the authored content for the text page associated with the navigating keyword (i.e., “location” or “1”) is then delivered to the user mobile device (502) in a subsequent GTP message. As described above, the representation of navigating keywords (544) using meaningful labels or short hand identifiers and the use of navigating keywords (544) to index the respective text pages are applicable only within the displayed text page, which is the zucca home text page, in this instance. Said another way, and as illustrated in FIGS. 3G and 3H below, the keyword “location” or “1” may be associated with different effects when used in a context other than replying to a GTP message delivering the zucca home text page.

FIG. 3E shows the user mobile device (502) displaying an example user message (551) containing the pre-designated keyword (552) (i.e., Wikipedia) as selected by the user from the example GTP home text page shown in FIG. 3B above or otherwise obtained by the user from an advertisement distributed, for example, by an operator of the GTP promoting built-in features of the GTP. As shown in FIG. 3E, the pre-designated keyword (552) (i.e., Wikipedia) is followed by user data (555) (i.e., “window”) in the user message (551) to initiate a search for information relating to user data (555) (i.e., “window”) within the Wikipedia textsite. To facilitate this, textsite map (119e) of the GTP data (518e) includes Wikipedia text page map (159c) describing relevant syntax information applicable to the Wikipedia textsite. For example, the Wikipedia text page map (159c) may relate to a home text page or a text page other than the home text page of the Wikipedia textsite. The GTP home text page map (159a) and Zucca home text page map (159b) are essentially the same as the GTP home text page map (149a) and Zucca home text page map (149b) shown in FIG. 3D above.

FIG. 3F shows the user mobile device (502) displaying an example wikipedia text page delivered in a GTP message (561) responding to the user message (531) described above. As shown, the example wikipedia text page contains search result relating to the user data (555) (i.e., “window”).

FIG. 3G shows the user mobile device (502) displaying an example user message (571) containing the pre-designated keyword (572) (i.e., location, as reflected by the entry location (512d) in keywords (112g) of the GTP data (518g)), for example obtained by the user in a GTP user guide (e.g., online user guide). As shown in FIG. 3E, the pre-designated keyword (572) (i.e., location) is followed by user data (575) (i.e., “San Diego”) in the user message (571) to set a global user location parameter throughout the GTP. Accordingly, for example and as described in FIGS. 3I and 3J below, a textsite registered with the GTP may utilize this global user location parameter set by the user for performing related activities, such as searching for weather information associated with the user location reflected in this global user location parameter. In another example, the textsite may overwrite this global user location parameter by a locally defined location keyword, as described in FIG. 3D above. The GTP home text page map (179a), Zucca home text page map (179b), and Wikipedia home text page map (179c) are essentially the same as the GTP home text page map (159a), Zucca home text page map (159b), and Wikipedia home text page map (159c) shown in FIG. 3E above.

FIG. 3H shows the user mobile device (502) displaying an example GTP text page delivered in a GTP message (581) responding to the user message (571) described above. As shown, the example GTP text page contains confirmation to the user data (575) (i.e., “San Diego”) and navigating tips describing a pre-designated keyword “ ” represented by the word “blank” (584) as reflected by the entry “blank” (512e) in keywords (112h) of the GTP data (518h). Based on the displayed navigating tips, the GTP may identify a previous session (e.g., a previous text page) from a user navigation trace for delivering to the user mobile device (502) upon receiving a user message containing the pre-designated keyword “ ” represented by the word “blank” (584). An example user navigation trace is the sequence of textsites traversed by the user as illustrated in FIGS. 3A through 3G above, which may be tracked by the GTP for assisting user textsite navigation. Other examples of pre-designated navigating keywords or syntax associated with the GTP may include a globally reserved single text digit (e.g., “0”) or text string (e.g., “.”) used for re-directing to a home page of the currently displayed textsite, a forward text page in the user navigation trace, or other pre-defined text pages. Similar to the use of the pre-designated keyword “location” (572), such pre-designated navigating keywords (e.g., “,” “0,” “.,” etc.) may be utilized or overwritten by a textsite based on syntax information defined in a corresponding textsite map by the publisher. The textsite map (119h) is essentially the same as the textsite map (119g) as shown in FIG. 3G above.

FIG. 3I shows the user mobile device (502) displaying an example user message (591) containing the pre-designated keyword (592) (i.e., weather) as selected by the user from the example GTP home text page shown in FIG. 3B above or otherwise obtained by the user from an advertisement distributed, for example, by an operator of the GTP promoting built-in features of the GTP.

FIG. 3J shows the user mobile device (502) displaying an example weather text page maintained by the GTP, which is delivered in a GTP message (593) in response to the user message (591) described above. As shown, the example weather text page illustrate a customized home text page for the weather textsite defined by the global user location parameter described in FIGS. 3G and 3H above.

FIGS. 4A-4H show various screenshots illustrating examples of using TMS protocol, or other network protocol requiring a data plan, during an application session in accordance with one or more embodiments of the invention. Although FIGS. 4A-4H show implementation examples of embodiments of the invention, those skilled in the art will appreciate that there may be other ways in which to implement embodiments of the invention, and that the example screenshots are not meant to limit the scope of the invention.

FIG. 4A shows a screenshot A (410) of a user client device (e.g., a mobile device) connected to a cellular network. In particular, the screenshot A (410) is captured at the beginning of a client server application session between the user client device and a computing platform “txtWeb.” Specifically, the screenshot A (410) includes the message A (412), which is a homepage welcome message requesting the user to accept the terms of service for accessing txtWeb. For example, the terms of service may include HTTP connection bandwidth metering charge arrangement. Upon the user clicking on the “Yes” button, the user client device automatically sends a user identifier (e.g., an encrypted phone number or other identifier of the user client device) to txtWeb to register the client server application session. This registration message is sent using the HTTP protocol requiring a premium data plan of the cellular network. In response, txtWeb allocates a user data set to store any information regarding the registered client server application session. As noted above, this user data set is tagged with the user identifier. Based on a default configuration, this registered client server application session uses the HTTP protocol to access txtWeb.

FIG. 4B shows a screenshot B (420) of the user client device (e.g., a mobile device). Specifically, the screenshot B (420) is captured from a touch-based graphical user interface (GUI). For example, a user can request movie show time listing by touching the touch field A (422), browse an encyclopedia by touching the touch field B (423), or access weather forecast by touching the touch field C (424). In one or more embodiments, upon the user touching each touch field, a corresponding webpage link is sent by the user client device using HTTP protocol to retrieve requested information from a News and Entertainment website “News & Ent” hosted on txtWeb. In one or more embodiments, the webpage link is an example of the UI data item described in reference to FIG. 2A above.

FIG. 4C shows a screenshot C (430) of the user client device displaying the alert (431) superimposed over the touch-based GUI as shown in FIG. 4B above. In particular, the HTTP connection is either lost due to network condition or manually turned off by the user. For example, the connection loss may have been detected by the user client device. Because of the detected connection loss, the alert (431) is displayed to request user permission to use the TMS protocol via the cellular phone network as a back up connection to continue the application session. Upon the user clicking “Yes” to the alert (431), the user client device switches to use the TMS protocol via the cellular phone network to continue the application session.

FIG. 4D shows a screenshot D (440) of the user client device subsequent to the user clicking “Yes” to the alert (431) as shown in FIG. 4C. In particular, the banner (441) of the screenshot D (440) indicates that the displayed text page is sent as a message D (442) from a textsite “LM-txtWeb” hosted on txtWeb. Specifically, the displayed text page includes a text version of the homepage welcome message (i.e., message A (412) of FIG. 4a) from txtWeb confirming the user registration to accept the terms of service for accessing txtWeb. As shown, the displayed text page addresses the user using the unencrypted mobile phone number (444) based on the previously sent user identifier used in the registration process. In addition, the home page includes the link structure (445), which indicates that the shorthand identifiers “A,” “B,” and “C” can be used to represent the navigating keywords “@movies,” “@wikipedia,” and “@weather,” respectively. The link structure (445) is equivalent to the touch fields of the aforementioned touch-based GUI shown in FIG. 4B. In one or more embodiments, the short hand identifiers “A,” “B,” and “C” and the navigating keywords “@movies,” “@wikipedia,” and “@weather” are examples of the short hand identifier and navigating keyword described in reference to FIG. 2A above. Specifically, short hand identifiers “A,” “B,” and “C” are associated with the web links of the touch-based GUI shown in FIG. 4B and are assigned to represent the navigating keywords “@movies,” “@wikipedia,” and “@weather,” respectively.

By entering the shorthand identifier “A” into the text entry field D (446) and clicking the send button, the user client device sends the shorthand identifier “A” to LM-txtWeb using the TMS protocol. In response, the user client device receives a return TMS message from LM-txtWeb using the TMS protocol. Specifically, the return TMS message contains movie show time listing since the shorthand identifier “A” represents the navigating keyword “@movies.” In one or more embodiments, LM-txtWeb converts the shorthand identifier “A” back to the navigating keyword “@movies,” which is used to retrieve a movie information home text page that was pre-converted from a movie information home webpage of the website “News & Ent.” In one or more embodiments, LM-txtWeb converts the shorthand identifier “A” back to the navigating keyword “@movies,” which is mapped to the corresponding web link for sending to the web server hosting “News & Ent.” The movie information home webpage of the website “News & Ent” is then retrieved and returned to TM-txtWeb, which dynamically converts it to the movie information home text page. Whether pre-converted or dynamically converted on demand, the movie information home text page is inserted in the return TMS message for sending back to the user client device.

In one or more embodiments, the return TMS message is presented to the user in the same touch-based GUI when the HTTP protocol is used for the application session. FIG. 4E shows an example of presenting the return message in the touch-based GUI. In one or more embodiments, the return TMS message is presented to the user in a text based UI that is different from the touch-based GUI. FIG. 4F shows an example of presenting the return message in the text based UI.

FIG. 4E shows a screenshot E (450) of the user client device using the touch-based GUI to present the returned TMS message from LM-txtWeb regarding movie information home page. In one or more embodiments, the mobile application executing on the user client device extracts movie information home page from the return TMS message and reformats it for presenting using the touch-based GUI. In particular, the screenshot E(450) shows a touch field E (451) allowing the user to touch one of the displayed city names for selecting user location where movie show time listing is to be retrieved.

FIG. 4F shows a screenshot F (460) of the user client device displaying the return TMS message as the message F (461). As shown, the message F (461) is essentially the movie information home text page that includes the dynamically assigned link (463), which indicates that the shorthand identifier “D” can be used to specify a user entered location as a configuration setting of the movie information service. The use of the shorthand identifier “D” as a syntax element to specify a movie interest location is referred to as the semantic context of the shorthand identifier “D.” The shorthand identifier “D” has been dynamically selected from a pool of 26 letters on a rotation basis after the shorthand identifiers “A,” “B,” and “C” were previously assigned. Accordingly, the semantic context of the shorthand identifier “D” is stored as the dynamically assigned link (463) in the user data set allocated when registering the client server application session shown in FIG. 4A. To illustrate the dynamic nature of the shorthand identifier assignment, consider an alternative scenario if the user would have entered the shorthand identifier “C” instead of “A” into the text entry field D (446) and clicking the send button. Because the shorthand identifier “C” represents the navigating keyword “@weather,” the next available shorthand identifier “D,” selected from the pool of 26 letters on a rotation basis after the shorthand identifiers “A,” “B,” and “C” were previously assigned, would have been assigned to a different navigating keyword associated with the weather page instead of the movie interest location shown in FIG. 4F.

Upon the user entering the shorthand identifier “D” followed by a name of the city “Bengaluru” into the text entry field E (464) and clicking the send button, the user client device sends the text string “D Bengaluru” to LM-txtWeb using the TMS protocol. In response, LM-txtWeb stores the text string “Bengaluru” as a location parameter (i.e., a configuration setting) of the movie information service. In one or more embodiments, the movie information service provided by LM-txtWeb is an application that allows movie information to be accessed.

FIG. 4G shows a screenshot G (470) of the user client device displaying the message H (482) returned by LM-txtWeb regarding movie show time listing. Specifically, the movie show time listing includes the dynamically assigned links (483) indicating that the shorthand identifiers “L,” “N,” “0,” “P,” and “Q” are dynamically assigned to represent the navigation keywords “Race 2,” “Inkaar,” “Akaashvani,” “Matru Ki Bijlee Ka Mandola,” and “Mumbai Mirror,” respectively, which are names of movies. These shorthand identifiers “L,” “N,” “0,” “P,” and “Q” have been dynamically selected from a pool of 26 letters on a random basis after the shorthand identifiers “A,” “B,” “C,” and “D” were previously assigned. Accordingly, the association of these shorthand identifiers to the corresponding navigating keywords are stored as the dynamically assigned links (483) in the user data set allocated when registering the client server application session shown in FIG. 4A. In this example, because these shorthand identifiers “L,” “N,” “0,” “P,” and “Q” are selected from the pool of 26 letters on a random basis, the same navigating keywords of these movie names “Race 2,” “Inkaar,” “Akaashvani,” “Matru Ki Bijlee Ka Mandola,” and “Mumbai Mirror” may be assigned different shorthand identifiers next time when the user registers another client application session to browse the movie information. In another example, when the user registers another client application session to browse the movie information in a different city, these shorthand identifiers “L,” “N,” “0,” “P,” and “Q” are to be assigned to different movie name navigating keywords depending on what may be showing in the movie theaters of this different city.

FIG. 4H shows a screenshot H (480) of the user client device using the touch-based GUI to present the returned TMS message from LM-txtWeb regarding movie show time listing. In one or more embodiments, the mobile application executing on the user client device extracts movie show time listing from the return TMS message and reformat it presenting using the touch-based GUI. In particular, the screenshot H (480) shows a touch field G (471) allowing the user to touch one of the displayed movie names to request corresponding movie show times to be retrieved.

Embodiments of the invention may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 5, the computing system (600) may include one or more computer processor(s) (602), associated memory (604) (e.g., random access memory (RAM), cache memory, flash memory, etc.), one or more storage device(s) (606) (e.g., a hard disk, an optical drive such as a compact disk (CD) drive or digital versatile disk (DVD) drive, a flash memory stick, etc.), and numerous other elements and functionalities. The computer processor(s) (602) may be an integrated circuit for processing instructions. For example, the computer processor(s) may be one or more cores, or micro-cores of a processor. The computing system (600) may also include one or more input device(s) (610), such as a touchscreen, keyboard, mouse, microphone, touchpad, electronic pen, or any other type of input device. Further, the computing system (600) may include one or more output device(s) (608), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device. The computing system (600) may be connected to a network (612) (e.g., a local area network (LAN), a wide area network (WAN) such as the Internet, mobile network, or any other type of network) via a network interface connection (not shown). The input and output device(s) may be locally or remotely (e.g., via the network (612)) connected to the computer processor(s) (602), memory (604), and storage device(s) (606). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (600) may be located at a remote location and connected to the other elements over a network (612). Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for accessing content during a client server application session, comprising:
receiving, during the client server application session and by a user client device, an instruction to switch from using a network communication protocol to a text messaging service (TMS) protocol for data communication of the client server application session, wherein accessing the content is based on an user interface (UI) when the network communication protocol is used for the client server application session;
sending, by the user client device and in response to the instruction, a text identifier associated with a UI data item of the UI, wherein the text identifier is sent to a global textsite platform (GTP) using the TMS protocol, wherein the UI data item is for requesting a portion of the content from a computer server when the network communication protocol is used for the client server application session;
receiving, by the user client device and in response to sending the text identifier, a text page from the GTP using the TMS protocol, wherein the text page is derived from the portion of the content; and
presenting, by the user client device, the text page to a user during the client server application session.

2. The method of claim 1, wherein receiving the text page by the user client device comprises:
receiving, from the GTP, a TMS message comprising the text page and a validation code derived from the text identifier;
validating the TMS message based on the validation code and a sender phone number of the TMS message; and
extracting the text page from the TMS message in response to validating the TMS message.

3. The method of claim 1,
wherein the text page is presented to the user using a TMS user interface separate from the UI.

4. The method of claim 1, wherein presenting the text page to the user comprises:
presenting information in the text page to the user using the UI.

5. The method of claim 1, wherein sending the text identifier by the user client device comprises:
assigning, based on a pre-determined rule, the text identifier to the UI data item; and
sending, to the GTP, a TMS message comprising the text identifier and an association between the text identifier and the UI data item.

6. The method of claim 1,
wherein the GTP converts the text identifier back to the UI data item for sending to the computer server,
wherein the computer server retrieves the portion of the content based on the UI data item for returning to the GTP, and
wherein the GTP converts the portion of the content into the text page.

7. The method of claim 1,
wherein the portion of the content is stored as a webpage of a website hosted on the computer server, and
wherein the UI data item comprises a link referencing the webpage.

8. The method of claim 7,
wherein the website is converted to a textsite hosted by the GTP,
wherein the text page is converted from the webpage and stored in the textsite as referenced by the text identifier, and
wherein the text page is retrieved from the textsite based on the text identifier for sending to the user client device.

9. The method of claim 7,
wherein the GTP converts the text identifier back to the UI data item for sending to the computer server,
wherein the computer server retrieves, in response to receiving the UI data item, the webpage based on the link for returning to the GTP, and
wherein the GTP converts the webpage to the text page for sending to the user client device.

10. A system for accessing content during a client server application session, comprising:
a computer server storing the content and coupled to a global textsite platform (GTP); and
a user client device coupled to the GTP and comprising a processor and memory storing instructions when executed by the processor comprising functionalities to:
receive, during the client server application session, an instruction to switch from using a network communication protocol to a text messaging service (TMS) protocol for data communication of the client server application session, wherein accessing the content is based on an user interface (UI) when the network communication protocol is used for the client server application session;
send, in response to the instruction, a text identifier associated with a UI data item of the UI, wherein the text identifier is sent to the GTP using the TMS protocol, wherein the UI data item is for requesting a portion of the content from the computer server when the network communication protocol is used for the client server application session;
receive, in response to sending the text identifier, a text page from the GTP using the TMS protocol, wherein the text page is derived from the portion of the content; and
present the text page to a user during the client server application session.

11. The system of claim 10, wherein receiving the text page from the GTP comprises:
receiving, from the GTP, a TMS message comprising the text page and a validation code derived from the text identifier;
validating the TMS message based on the validation code and a sender phone number of the TMS message; and
extracting the text page from the TMS message in response to validating the TMS message.

12. The system of claim 10,
wherein the text page is presented to the user using a TMS user interface separate from the UI.

13. The system of claim 10, wherein presenting the text page to the user comprises:
presenting information in the text page to the user using the UI.

14. The system of claim 10, wherein sending the text identifier by the user client device comprises:
assigning, based on a pre-determined rule, the text identifier to the UI data item; and
sending, to the GTP, a TMS message comprising the text identifier and an association between the text identifier and the UI data item.

15. The system of claim 10,
wherein the GTP converts the text identifier back to the UI data item for sending to the computer server,
wherein the computer server retrieves the portion of the content based on the UI data item for returning to the GTP, and
wherein the GTP converts the portion of the content into the text page.

16. The system of claim 10,
wherein the portion of the content is stored as a webpage of a website hosted on the computer server, and
wherein the UI data item comprises a link referencing the webpage.

17. The system of claim 16,
wherein the website is converted to a textsite hosted by the GTP,
wherein the text page is converted from the webpage and stored in the textsite as referenced by the text identifier, and
wherein the text page is retrieved from the textsite based on the text identifier for sending to the user client device.

18. The system of claim 16,
wherein the GTP converts the text identifier back to the UI data item for sending to the computer server,
wherein the computer server retrieves, in response to receiving the UI data item, the webpage based on the link for returning to the GTP, and
wherein the GTP converts the webpage to the text page for sending to the user client device.

19. A non-transitory computer readable storage medium comprising software instructions for accessing content during a client server application session, that when executed, comprise functionality for:
receiving, during the client server application session and by a user client device, an instruction to switch from using a network communication protocol to a text messaging service (TMS) protocol for data communication of the client server application session, wherein accessing the content is based on an user interface (UI) when the network communication protocol is used for the client server application session;
sending, by the user client device and in response to the instruction, a text identifier associated with a UI data item of the UI, wherein the text identifier is sent to a global textsite platform (GTP) using the TMS protocol, wherein the UI data item is for requesting a portion of the content from a computer server when the network communication protocol is used for the client server application session;
receiving, by the user client device and in response to sending the text identifier, a text page from the GTP using the TMS protocol, wherein the text page is derived from the portion of the content; and
presenting, by the user client device, the text page to a user during the client server application session.

20. The non-transitory computer readable storage medium of claim 19, wherein receiving the text page by the user client device comprises:
receiving, from the GTP, a TMS message comprising the text page and a validation code derived from the text identifier;
validating the TMS message based on the validation code and a sender phone number of the TMS message; and
extracting the text page from the TMS message in response to validating the TMS message.

21. The non-transitory computer readable storage medium of claim 19,
wherein the text page is presented to the user using a TMS user interface separate from the UI.

22. The non-transitory computer readable storage medium of claim 19, wherein presenting the text page to the user comprises:
presenting information in the text page to the user using the UI.

23. The non-transitory computer readable storage medium of claim 19, wherein sending the text identifier by the user client device comprises:
assigning, based on a pre-determined rule, the text identifier to the UI data item; and
sending, to the GTP, a TMS message comprising the text identifier and an association between the text identifier and the UI data item.

24. The non-transitory computer readable storage medium of claim 19,
wherein the GTP converts the text identifier back to the UI data item for sending to the computer server,
wherein the computer server retrieves the portion of the content based on the UI data item for returning to the GTP, and
wherein the GTP converts the portion of the content into the text page.

25. The non-transitory computer readable storage medium of claim 19,
wherein the portion of the content is stored as a webpage of a website hosted on the computer server, and
wherein the UI data item comprises a link referencing the webpage.

26. The non-transitory computer readable storage medium of claim 25,
wherein the website is converted to a textsite hosted by the GTP,
wherein the text page is converted from the webpage and stored in the textsite as referenced by the text identifier, and
wherein the text page is retrieved from the textsite based on the text identifier for sending to the user client device.

27. The non-transitory computer readable storage medium of claim 25,
wherein the GTP converts the text identifier back to the UI data item for sending to the computer server,
wherein the computer server retrieves, in response to receiving the UI data item, the webpage based on the link for returning to the GTP, and
wherein the GTP converts the webpage to the text page for sending to the user client device.
